(19) United States
(12) Patent Application Publication
(10) Pub. No.: US 2023/0340639 A1
(43) Pub. Date: Oct. 26, 2023

(54) RECOVERY OF RARE EARTH ELEMENTS FROM ACIDIC SOLUTIONS

(71) Applicant: THE PENN STATE RESEARCH FOUNDATION, University Park, PA (US)

(72) Inventors: Behzad VAZIRI HASSAS, State College, PA (US); Mohammad REZAEE, State College, PA (US); Sarma V. PISUPATI, State College, PA (US)

(21) Appl. No.: 17/796,385

(22) PCT Filed: Jan. 29, 2021
(86) PCT No.: PCT/US2021/015812

§ 371 Date: Jul. 29, 2022

Related U.S. Application Data
(60) Provisional application No. 62/967,650, filed on Jan. 30, 2020.

(51) Int. Cl. C22B 59/00; C22B 3/44

(52) U.S. Cl. CPC C22B 59/00; C22B 3/44

(57) ABSTRACT

Disclosed herein are methods for the recovery of one or more rare earth elements (REEs). More specifically, disclosed herein is a method comprising n stages, wherein each stage comprises treating a sample comprising one or more REEs with a reagent to form a carbonate, hydroxycarbonate, bicarbonate of one or more rare earth elements. The sample’s pH is adjusted, and the sample is aged to form solid and liquid fractions, where the solid fraction comprises a precipitated salt of the REEs. The method is repeated an n number of times to maximize the recovery % of REEs. This abstract is intended as a scanning tool for the purpose of searching in the particular art and is not intended to be limiting of the present disclosure.

### CROSS-REFERENCE TO RELATED APPLICATIONS

This application claims the benefit of U.S. Provisional Application No. 62/967,650, filed Jan. 30, 2020, the content of which is incorporated herein by reference in its entirety.

### BACKGROUND

In recent years, the wide range of applications, from green energy production to recent advanced technology, has significantly raised the demand for and price of rare earth elements (REEs) (Binnemas, P. T. et al., “Recycling of rare earths: a critical review,” Journal of Cleaner Production, vol. 51, pp. 1-22, 2013; U.S. Geological Survey, Mineral commodity summaries 2019, U.S. Geological Survey, 2019, p. 200). Rare earth elements (REE) are a group of 17 elements, including the 15 lanthanides along with scandium and yttrium, with similar physicochemical properties (V. Balaram, “Rare earth elements: A review of applications, occurrence, exploration, analysis, recycling, and environmental impact,” Geoscience Frontiers, vol. 10, pp. 1285-1303, 2019). Except for La, Ce, Gd, and Lu, the d-orbital is not part of the electron configuration of lanthanides, in which the f-orbital is being filled, and the outermost shell remains the same as the atomic number increases. Therefore, due to their very close atomic properties and atomic radii, these elements generally exist in the trivalent oxidation state (D. Merten et al., “Determination of Rare Earth Elements in Acid Mine Drainage by Inductively Coupled Plasma Mass Spectrometry,” Microchim. Acta, vol. 148, pp. 163-170, 2004; A. Jordens, at al., “A review of the beneficiation of rare earth element bearing minerals,” Minerals Engineering, vol. 41, pp. 97-114, 2013) and substitute each other in different ratios in their host minerals (R. J. et al., Rare earth elements: A review of production, processing, recycling, and associated environmental issues, Office of Research and Development - US EPA, 2012).

Due to the supply risk and scarcity of feasible primary resources, REEs have been classified as critical elements by both the EU (European Commission, “Study on the review of the list of critical raw materials - Critical Assessments,” Luxembourg, 2017; European Commission, “Report on Critical Raw Materials and the Circular Economy,” Luxembourg, 2018) and the US (Department of the Interior, Final List of Critical Minerals - Federal Register 83 FR 23295, Federal Register, 2018), and therefore the solutions addressing their supply shortage, recycling and recovering of REEs from secondary sources is crucial.

However, since the secondary sources are often present in an acidic environment (such as acid mine drainage, natural leachate, and pregnant leaching solutions), in order to comport to the environmental regulations and to achieve a meaningful recovery yield, the proposed methods often require neutralization of the initial materials to relatively high pHs. This high pH requirement for better recovery of REEs has economic drawbacks due to high chemical consumption (considering the volume of natural leachates, mining draining solutions, or recycling industry) and environmental concerns as the pH of discharge should be regulated.

Thus, there is a need for more efficient and environmentally friendly recovery methods. Also, there is a need for the methods that allow efficient recovery of one or more rare earth elements at pHs that are close to a neutral pH, and thus eliminating unnecessary current process steps. These needs and other needs are at least partially satisfied by the present disclosure.

### SUMMARY

The present invention is directed to a method of recovery rare earth elements. The disclosed method is directed to stage precipitation of the rare earth elements as their carbonate salts.

In one aspect disclosed herein is a method comprising n stages, wherein the method comprises: a first of the n stages comprising: a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, phosphate salt, dihydrogen phosphate salt, hydrogen phosphate salt, or any combinations thereof of the one or more rare earth elements for a first predetermined period of time; b) adjusting the first predetermined pH of the first solution to reach a second predetermined pH, wherein the second predetermined pH is higher than the first predetermined pH; c) aging the first solution for a second predetermined period of time at conditions effective to form a first liquid fraction and a first solid fraction, wherein the first solid fraction comprises at least one of the one or more rare earth element salts; d) separating the first solid fraction from the first liquid fraction; and repeating steps a)-d) for n times, wherein: a first solution in step a) of each subsequent stage is substantially similar to a first liquid fraction formed in step d) of each preceding stage; wherein a first predetermined pH at step a) of each subsequent stage is higher than a first predetermined pH at step a) of each preceding stage; wherein a second predetermined pH in step b) of each subsequent stage is higher than the first predetermined pH at step a) of the same stage, and wherein n is at least 2 stages.

In certain aspects, disclosed herein is a method comprising n stages, wherein the method comprises: a first of the n stages comprising: a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, or any combinations thereof of the one or more rare earth elements for a first predetermined period of time; b) adjusting the first predetermined pH of the first solution to reach a second predetermined pH, wherein the second predetermined pH is higher than the first predetermined pH; c) aging the first solution for a second predetermined period of time at conditions effective to form a first liquid fraction and a first solid fraction, wherein the first solid fraction comprises at least one of the one or more rare earth element salts; d) separating the first solid fraction from the first liquid fraction; and repeating steps a)-d) for n times, wherein: a first solution in step a) of each subsequent stage is substantially similar to a first liquid fraction formed in step d) of each preceding stage; wherein a first predetermined pH at step a) of each subsequent stage is higher than a first predetermined pH at step a) of each preceding stage; wherein a second predetermined pH in step b) of each subsequent stage is higher than the first predetermined pH at step a) of the same stage; and wherein n is at least 2 stages.

In still further aspects, in the methods disclosed herein, a total second quantity of the one or more rare earth elements comprises a sum of each of the second quantities measured at each of n^{th} stages, and wherein the total second quantity of the one or more rare earth elements comprises at least 70 % of the first quantity of the one or more rare earth elements present in the first solution in the first stage.

In yet further aspects, the methods disclosed herein demonstrate that at least 70 % of the total second quantity of the one or more rare earth elements is collected at a stage having a second predetermined pH at least 0.5 unit lower when compared to a substantially identical reference method that does not comprise step a) of treating the first solution with the reagent.

In yet further aspects, disclosed herein are methods comprising: a) treating a solution having a first predetermined pH and comprising a first quantity of one or more rare earth elements (REEs) and a second quantity of one or more of iron, aluminum, calcium, magnesium, or manganese with a reagent under conditions effective to form: i) a salt comprising one or more of a carbonate of one or more rare earth element, bicarbonate of one or more rare earth element, hydroxycarbonate of one or more rare earth element or a combination thereof, and ii) a precipitate of one or more of iron, aluminum, calcium, magnesium, or manganese, or a combination thereof, for a first predetermined period of time to form a first liquid fraction and a first solid fraction, wherein the first solid fraction comprises the salt of one or more of iron, aluminum, calcium, magnesium, or manganese; b) adjusting the first predetermine pH of the solution to reach a second predetermined pH, wherein the second pH is higher than the first predetermined pH; c) aging the first solution for a second predetermined period of time at conditions effective to form a second liquid fraction and a second solid fraction, wherein the second solid fraction comprises at least one of the carbonate of one or more rare earth element, bicarbonate of one or more rare earth element, hydroxycarbonate of one or more rare earth element, or a combination thereof ; and d) collecting the first solid fraction and the second solid fraction.

Additional aspects of the disclosure will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1A depicts a schematic representation of the experimental setup.

FIG. 1B depicts a graph of cumulative total rare earth elements (TREEs) recovery and concentration at various stages of precipitation using NaOH.

FIGS. 2A-2C depict an SEM image and an EDS mapping of precipitates at pH 7 using NaOH.

FIG. 3 depicts a graph of individual REE recovery distribution at various stages of NaOH precipitation.

FIG. 4A depicts a tetrad classification of effective precipitation pH of individual REE; FIG. 4B depicts the recovery of individual REE at various stages of NaOH precipitation.

FIG. 5 depicts a graph of cumulative total rare earth elements (TREEs) recovery and concentration at various stages of precipitation using CO₂/NaOH.

FIG. 6 depicts an SEM image and an EDS mapping of precipitates at pH 7 using CO₂/NaOH.

FIGS. 7A-7C depict an SEM image and an EDS mapping of various metals’ formations: FIG. 7A depicts images of aluminum formation; FIG. 7B depicts images of calcium formation; and FIG. 7C depicts images of manganese formation.

FIG. 8 depicts a graph of individual REE recovery distribution at various stages of NaOH precipitation.

FIG. 9A depicts a solubility product constant of individual REE-hydroxide and REE-carbonate, and FIG. 9B depicts an enthalpy of hydration of individual REE.

FIG. 10A depicts a tetrad classification of effective precipitation pH of individual REE; FIG. 10B depicts the recovery of individual REE at various stages of CO₂/NaOH precipitation

FIG. 11 depicts a plot of cumulative recovery of Al and Fe in precipitates.

FIG. 12 depicts a plot of a hydroxyl ion consumption and a cumulative mass of precipitates at each pH.

FIGS. 13A-D depicts a cumulative recovery and grade of TREEs in staged precipitation of AMD using: FIG. 13A-Na₂CO₃, FIG. 13B-Na₂HPO₄, FIG. 13C-Na₂SO₄, and FIG. 13D —(NH₄)OH.

FIG. 14 depicts a cumulative recovery and grade of TREEs in staged precipitation of AMD using (NH₄)₂SO₄ (top), (NH₄)HCO₃ (bottom).

FIG. 15A depicts a C_{outlook,} and FIG. 15B depicts a H/L ratio of the precipitates in staged precipitation of AMD using various ligands.

FIG. 16 depicts a calculated saturation index of Y, La, and Nd versus pH for possible hydroxide, phosphate, and carbonate formations.

FIGS. 17 depicts a speciation and Pourbaix diagrams of La (1 mM) in the presence of various ligands (10 mM).

FIG. 18 depicts a cumulative recovery of Al and Fe in staged precipitation of AMD using various chemicals.

FIG. 19 depicts a recovery of elements in the proposed two-step AMD treatment process at pH 5 and 7 using Na₂CO₃ for TREEs, Al, and Fe.

FIGS. 20A-20C depict a Pourbaix diagram of La (FIG. 20A), Eu (FIG. 20B), and Yb (FIG. 10C) (1 mM) in the presence of SO₄²⁻ (10 mM).

FIG. 21 depicts a Pourbaix diagram of Ca (1 mM).

FIG. 22 depicts a Pourbaix diagram of Mg (1 mM).

FIG. 23 depicts a Pourbaix diagram of Mn (1 mM).

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the singular forms “a,” “an,” and “the” include plural referents unless the context clearly dictates otherwise. Thus, for example, reference to a “rare earth element” includes aspects having two or more such rare-earth elements unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the terms “optional” or “optionally” mean that the subsequently described event or circumstance may or may not occur, and that the description includes instances where said event or circumstance occurs and instances where it does not.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

It is also to be understood that the terminology used herein is for the purpose of describing particular aspects only and is not intended to be limiting. As used in the specification and in the claims, the term “comprising” can include the aspects “consisting of” and “consisting essentially of.”

For the terms “for example” and “such as,” and grammatical equivalences thereof, the phrase “and without limitation” is understood to follow unless explicitly stated otherwise.

As used herein, the term “substantially,” when used in reference to a composition, refers to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature or component.

As used herein, the term “substantially,” in, for example, the context “substantially free” refers to a composition having less than about 1 % by weight, e.g., less than about 0.5 % by weight, less than about 0.1 % by weight, less than about 0.05 % by weight, or less than about 0.01 % by weight of the stated material, based on the total weight of the composition.

As used herein, the term “substantially,” in, for example, the context “substantially identical” or “substantially similar” refers to a method, a composition, article, or a component that is at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by similar to the method, composition, article, or the component it is compared to.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, the terms “substantially identical reference composition” or “substantially identical reference method” refer to a reference composition or method comprising substantially identical components or method steps in the absence of an inventive component or a method step. In another exemplary embodiment, the term “substantially,” in, for example, the context “substantially identical reference compositions,” refers to a reference composition or a method step that comprises substantially identical components or method steps, and wherein an inventive component or a method step is substituted with a common in the art component or a method step.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Methods

It is known that the formations and variety of complexes in aqueous systems depend on available anions, ligands, chelating agents, and type and concentration of elements in the solution (M. Pourbaix, Atlas of Electrochemical Equilibria in Aqueous Solutions, Houston, Texas: Pergamon Press Ltd., 1966). REEs can form complexes with various anions and ligands; for example, REEs can form complexes with anions such as SO₄²⁻, PO₄³⁻, F⁻, COO²⁻, C₂O₄²⁻, EDTA (E. Kim et al., “Aqueous stability of thorium and rare earth metals in monazite hydrometallurgy: Eh-pH diagrams for the systems Th-, Ce-, La-, Nd- (PO4)-(SO4)-H2O at 25° C.,” Hydrometallurgy, Vols. 113-114, pp. 67-78, 2012; I. S. Al-Nafai, Application of Pourbaix Diagrams in the Hydrometallurgical Processing of Bastnasite (M.Sc. Thesis), The Pennsylvania State University, 2015; R. Janicki, A. et al., “Carboxylates of rare earth elements,” Coordination Chemistry Reviews, vol. 340, pp. 98-133, 2017; B. Weaver, “Fractional Separation of Rare Earths by Oxalate Precipitation from Homogeneous Solution,” Analytical Chemistry, vol. 26, no. 3, pp. 479-480, 1954; D. Beltrami et al., “Recovery of yttrium and lanthanides from sulfate solutions with high concentration of iron and low rare earth content,” Hydrometallurgy, vol. 157, pp. 356-362, 2015; R. H. Byrne et al., “Rare earth precipitation and coprecipitation behavior: The limiting role of PO43- on dissolved rare earth concentrations in seawater,” Geochimica et Cosmochimica Acta, vol. 57, no. 3, pp. 519-526, 1993).

Ligands are also known to affect the Kₛₚ of different REEs salts. For example, it was shown that (F. H. Firschlng et al., “Solubility products of the trivalent rare-earth phosphates,” Journal of Chemical and Engineering Data, vol. 36, no. 1, pp. 93-95, 1991) the Kₛₚ of rare-earth phosphates of Y, Gd, Tb, Dy, and Lu is conspicuously higher than that of the rest of the REEs, which provides a window to separate these elements from the solution by selective precipitation.

Carbonate (CO₃²⁻) is an anion with a crucial role in the formation of natural resources and is widely used in hydrometallurgical processes. The studies (R. C. Stover et al., “Evaluation of Metals in Wastewater Sludge,” Water Pollution Control Federation, vol. 48, no. 9, pp. 2165-2175, 1976) of 12 wastewater sludges for metal recovery showed that the metal-carbonates are among the highly stable and common metal formations, which indicates that the formation of metal-carbonates is favorable. Moreover, the standard Gibbs free energy of formation (ΔG°_{f}) of the M₂(CO₃)₃ for REE is considerably lower (more negative) than that of all other species including M³⁺, M(OH)₃, M₂O₃, and M(OH)₄⁻, where M denotes metals (D. G. Brookins, Eh-pH Diagrams for Geochemistry, Berlin: Springer-Verlag, 1988).

Mineral carbonation is also one of the techniques to address global warming by sequestering CO₂ through the dissolution of CO₂ in the water and formation of insoluble and stable metal carbonates as summarized in Eq. 1 (A. Sanna et al., “A review of mineral carbonation technologies to sequester CO2,” Chem Soc Rev, vol. 43, pp. 8049-8080, 2014).

$$M O + C {O}_{2} ↔ M C {O}_{3} + \text{Δ} H \qquad \text{(1)}$$

The formation of natural carbonates from atmospheric CO₂ is one of the prime and massive reactions that mainly controls the global carbon cycle since the carbonate formations are energetically favored (R. Berner et al., “The carbonate-silicate geochemical cycle and its effect on atmospheric carbon dioxide over the past 100 million years,” American Journal of Science, vol. 283, pp. 641-683, 1983; E. H. Oelkers et al., “Mineral Carbonation of CO2,” Elements, vol. 4, no. 5, pp. 333-337, 2008). Consequently, as a remedy for recent concerns in the global climate change issues, mineral carbonation is considered as one of the technologies widely available to control and sequester the CO₂ at the emission points (D. S. Goldberg, et al., “Co-Location of Air Capture, Subseafloor CO₂ Sequestration, and Energy Production on the Kerguelen Plateau,” Environmental Science & Technology, vol. 47, no. 13, pp. 7521-7529, 2013).

Also disclosed herein are aspects where additional ligands are used to form precipitates with REEs. The precipitation behavior of the cations in the solution strongly depends on their interactions with other ions in the aqueous system and the properties of the elements. The coordination number of an ion in the aqueous phase and its hydration energy determines its interactions with water molecules, further solvation, and polymerization. The coordination number of lanthanides (Ln) has been reported as 9, which gradually decreases by increasing the atomic number due to the lanthanide contraction. However, the coordination number of lanthanides in Ln-carbonates, Ln-phosphates, and Ln-sulfates has been reported as 10, 8, and 8, respectively. This difference in the ionic structure of lanthanides in the presence of various anions is an indication of their specific behavior in solvation, precipitation, and complexation.

In one aspect, disclosed herein is a method comprising n stages, wherein the method comprises: a first of the n stages comprising: a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, phosphate salt, dihydrogen phosphate salt, hydrogen phosphate salt, or any combinations thereof of the one or more rare earth elements for a first predetermined period of time; b) adjusting the first predetermined pH of the first solution to reach a second predetermined pH, wherein the second predetermined pH is higher than the first predetermined pH; c) aging the first solution for a second predetermined period of time at conditions effective to form a first liquid fraction and a first solid fraction, wherein the first solid fraction comprises at least one of the one or more rare earth element salts; d) separating the first solid fraction from the first liquid fraction; and repeating steps a)-d) for n times, wherein: a first solution in step a) of each subsequent stage is substantially similar to a first liquid fraction formed in step d) of each preceding stage; wherein a first predetermined pH at step a) of each subsequent stage is higher than a first predetermined pH at step a) of each preceding stage; wherein a second predetermined pH in step b) of each subsequent stage is higher than the first predetermined pH at step a) of the same stage, wherein n is at least 2 stages.

In yet further aspects, n can be any number of the stages designed to obtain the desired amount of REEs. For example, n can be 3, 4, 5, 6, 7, 8, 9, 10, 12, 15, 20, or even more. Again, it is understood that in some aspects, the n^{th} stage can be determined by the total amount of REEs present in the first solution. In yet other aspects, the n^{th} stage can be determined by the desired yield, recovery, and grade of the REEs and other metal precipitates.

In some aspects, the salt of one or more rare earth elements can comprise any known in the art salts. In some aspects, the salt of one or more rare earth elements comprises carbonates, bicarbonates, hydroxycarbonates, phosphates, dihydrogen phosphate, hydrogen phosphate, or a combination thereof. In yet further aspects, the salt of one or more rare earth elements comprises carbonates, hydroxycarbonates, bicarbonates, or a combination thereof.

In such exemplary aspects, any reagents that can form the disclosed above compounds can also be utilized. In some aspects, the reagent comprises a carbon dioxide gas, a carbonate salt, bicarbonate salt, phosphate salt, a dihydrogen phosphate salt, a hydrogen phosphate salt, or a combination thereof. While in still further aspects, these reagents that comprise any one of the disclosed herein carbonate salts, bicarbonate salts, the phosphate salts, the dihydrogen phosphate salts, and/or the hydrogen phosphate salts can be provided as a solution, as a solid, or as a combination thereof. In yet other aspects, the reagent is the carbon dioxide gas, the carbonate salt, the bicarbonate salt, or a combination thereof. In still further aspects, the one or more rare earth element salts formed under the disclosed conditions are carbonates. In still further aspects, the one or more rare earth element salts formed under the disclosed conditions are bicarbonates. In still further aspects, the one or more rare earth element salts formed under the disclosed conditions are hydroxycarbonates. In still further aspects, the one or more rare earth element salts formed under the disclosed conditions are a combination of carbonates, bicarbonates and/or hydrocarbonates.

In one aspect disclosed herein is a method comprising n stages, wherein the method comprises: a first of the n stages comprising: a) treating a first solution having a first predetermined pH and comprising a first quantity of one or more rare earth elements (REEs) with a reagent under conditions effective to form a salt of one or more rare earth element, wherein the salt comprises at least one of a carbonate, hydroxycarbonate, bicarbonate, or any combinations thereof for a first predetermined period of time; b) adjusting the first predetermined pH of the first solution to reach a second predetermined pH, wherein the second predetermined pH is higher than the first predetermined pH; c) aging the first solution for a second predetermined period of time at conditions effective to form a first liquid fraction and a first solid fraction, wherein the first solid fraction comprises at least one of the one or more rare earth element salts; d) separating the first solid fraction from the first liquid fraction; and repeating steps a)-d) for n times, wherein: a first solution in step a) of each subsequent stage is substantially similar to a first liquid fraction formed in step d) of each preceding stage; wherein a first predetermined pH at step a) of each subsequent stage is higher than a first predetermined pH at step a) of each preceding stage; wherein a second predetermined pH in step b) of each subsequent stage is higher than the first predetermined pH at step a) of the same stage, and wherein n is at least 2 stages.

In still further aspects, the reagent can comprise any reagent capable of forming a carbonate salt, bicarbonate, and/or a hydroxycarbonate salt with one or more rare earth elements. In still further aspects, the step of treating the REEs with the reagent can also form a salt comprising one or more rare earth element bicarbonates. In certain aspects, the reagent can comprise a carbon dioxide gas, or a carbonate salt, or a combination thereof. It is understood that the reagent comprising a carbonate salt and/or bicarbonate can be provided in any possible state, it can be a gas, a liquid, or a solid.

In certain exemplary and unlimiting aspects, the carbonate salt can comprise Na₂CO₃, CaCO₃, BaCO₃, MgCO₃, K₂CO₃, Li₂CO₃, and the like. In yet further aspects, the reagent is a carbon dioxide gas. In yet other aspects, the phosphate salts can comprise Na₃PO₄, K₃PO₄, Li₃PO₄, Ca₃(PO₄)₂, Ba₃(PO₄)₂, Mg₃(PO₄)₂. In yet other aspects, the dihydrogen phosphate salts can comprise NaH2PO4, KH2PO4, LiH2PO4, Ca(H2PO4)2, Ba(H2PO4)2, Mg(H2PO4)2. In yet other aspects, the hydrogen phosphate salts can comprise Na₂HPO₄, K₂HPO₄, Li₂HPO₄, CaHPO₄, BaHPO₄, MgHPO₄.

In some exemplary aspects, if needed, the reagent can also comprise additional salts such as sulfate salts. For example, and without limitations, the sulfate salts, if present, can comprise Na₂SO₄, K₂SO₄, Li₂SO₄, CaSO₄₂, BaSO₄, MgSO₄.

Due to a lower Henry’s constant, CO₂ dissolves in the water relatively more than other gases (C. J. Geankoplis, Transport Processes and Unit Operations, New Jersey: Prentice-Hall International. Inc., 1993), and therefore, it can be a good reagent to form the carbonate ion species (as a function of pH). The precipitation and recovery of REEs in the form of carbonate compounds using CO₂ as a source of carbonate ions in the system can be explained as follows (Eq. 2-5).

$$C {O}_{2} \left(g\right) + {H}_{2} O \left(l\right) ↔ {H}_{2} C {O}_{3} \left(a q\right) \qquad \text{(2)}$$

$${H}_{2} C {O}_{3} \left(a q\right) ↔ H C {O}_{3}^{-} \left(a q\right) + {H}^{+} \qquad \text{(3)}$$

$$H C {O}_{3}^{-} \left(a q\right) ↔ C {O}_{3}^{2 -} \left(a q\right) + {H}^{+} \qquad \text{(4)}$$

$$2 R E {E}^{3 +} \left(a q\right) + 3 C {O}_{3}^{2 -} \left(a q\right) ↔ R E {E}_{2} {\left(C {O}_{3}\right)}_{3} \left(s\right) \qquad \text{(5)}$$

The Kₛₚ of the REE carbonates has been reported on the orders of 10-³⁵ to 10-²⁰ (S. P. Cooper et al., “The radiochemistry of the rare earth: scandium, yttrium, and actinium,” National Academies, vol. 3020, 1961; F. H. Firsching et al., “Solubility products of the rare-earth carbonates,” Journal of Chemical & Engineering Data, vol. 31, no. 1, pp. 40-42, 1986; K. Spahiu et al., “A selected thermodynamic database for REE to be used in HLNW performance assessment exercises. No. SKB-TR--95-35,” Swedish Nuclear Fuel and Waste Management Co., Cerdanyola, Spain, 1995; A. Roine, “HSC Chemistry® [Software],” Outotec, 2015) which is considerably lower than that of REE-hydroxides.

In still further aspects, the first predetermined pH in step a) of the first stage can be dependent on a sample source from which the first solution has been prepared. It is understood the sample source can be any sample containing traces of REEs to be recovered. In still further aspects, the sample source can be a dilute solution of REEs. It is understood that in some exemplary and unlimiting aspects, the dilute solution can be defined as any solution having less than about 1,000 ppm, less than about 900 ppm, less than about 800 ppm, less than about 700 ppm, less than about 600 ppm, less than about 500 ppm, less than about 400 ppm, less than about 300 ppm, or less than about 200 ppm of a total amount of REEs present in that solution.

In certain aspects, the sample source can be one or more of electronic and industrial waste residues, mining and processing waste streams including pyrometallurgical processes slags, Bayer process residue (red mud), phosphoric acid production by-products (phosphogypsum), copper and iron processing tailings, coal and coal by-products (fly ash, coal refuse), and acid mine drainage (AMD) and associated sludge materials, and pregnant leaching solution of primary mineral resources. It was estimated, for example, that about 700 to 3400 tons per annum of REEs can be recovered from the northern Appalachian coal basin throughout West Virginia and Pennsylvania (C. R. Vass et al., “The Occurrence and Concentration of Rare Earth Elements in Acid Mine Drainage and Treatment By-products: Part 1— Initial Survey of the Northern Appalachian Coal Basin,” Mining, Metallurgy & Exploration, 2019).

In certain aspects, the first solution in the first stage comprises an acid mine drainage. In yet other aspects, the first solution in the first stage comprises electronic and industrial waste residues. In still further aspects, the first solution in the first stage comprises mining and processing waste streams. In still further aspects, the first solution in the first stage can comprise an acid mine drainage, natural leachate, pregnant leaching solutions, or a combination thereof. In still further aspects, the first solution in the first stage comprises phosphate, copper and iron processing tailings. In still further aspects, the first solution in the first stage comprises pregnant leaching solution of primary REEs and mineral resources. In yet further exemplary aspects, the first solution in the first stage is filtered prior to step a) of the first stage to remove coarse impurities.

In certain aspects, the first predetermined pH in step a) of the first stage can be from 0 to about 6, including exemplary values of about 0.5, about 1, about 1.5, about 2, about 2.5, about 3, about 3.5, about 4, about 4.5, about 5, and about 5.5. It is further understood that the first predetermined pH in step a) of the first stage can have any value between any two foregoing values. In certain exemplary and unlimiting aspects, the first predetermined pH in step a) of the first stage can be between about 2 to about 4.

REEs can be classified into two general groups as light REE (LREEs: Sc, La, Ce, Pr, Nd, Sm) and heavy REE (HREEs: Y, Eu, Gd, Tb, Dy, Ho, Er, Tm, Yb, Lu), of which the demand for the latter is higher owing to the lesser common natural occurrence (Y. Xiao et al., “Role of minerals properties on leaching process of weathered crust elution-deposited rare earth ore,” Journal of Rare Earths, vol. 33, no. 5, pp. 545-552, 2015).

In still further aspects, the one or more rare earth elements present in the first solution at the first stage comprises at least one or more of light rare earth elements (LREEs), at least one or more of heavy rare earth elements (HREEs), or a combination thereof. It is understood that the ratio of H/L can indicate the viability of the resource. The ratio of H/L is dependent on the type of the sample (for example, AMD vs. electronic waste) or even the region was the sample was collected.

In certain aspects, the higher H/L ratio can be indicative of the selective dissolution of heavy (high value) REEs in natural mine drainages (W. Zhang et al., “Rare earth elements recovery using staged precipitation from a leachate generated from coarse coal refuse,” International Journal of Coal Geology, vol. 195, pp. 189-199, 2018).

In certain aspects, the LREEs can comprise one or more of Sc, La, Ce, Pr, Nd, or Sm. In yet other aspects, the HREEs can comprise one or more of Y, Eu, Gd, Tb, Dy, Ho, Er, Tm, Yb, or Lu. In still further aspects, after the first solution having the first predetermined pH is treated with the reagent, for example, and without limitation, carbon dioxide gas in the first stage, the first predetermined pH is adjusted to reach a second predetermined pH. In such aspects, the second predetermined pH is higher than the first predetermined pH. It is understood that the step of adjusting can be achieved by the use of any reagent effective to increase the pH of the solution. For example, and without limitation, the pH adjustment at stage b) of the first stage and each subsequent stage of the n stage process comprises adding a base. In certain aspects, the base can comprise any bases known in the art. In certain aspects, the base can comprise a solution, a gas, a solid, or any combinations thereof. In some exemplary and unlimiting aspects, the base can comprise ammonium, ammonia hydroxide, hydroxides of alkali and alkaline earth metals, amines, or any combinations thereof. For example, and without limitations, the base can comprise one or more of NaOH, LiOH, KOH, NH₃, and/or NH₄OH. It is also understood that the base can be inorganic or organic, strong or weak. It is further understood that if, in some aspects, the need arises to decrease pH, any known in the art acids can be utilized. Again, acids can be inorganic or organic, strong, weak, or any combination thereof. It is also understood that the strength of the base or acid can be determined as it is known in the art.

In still further aspects, the first predetermined time needed for the treatment of the first solution in the first stage and any subsequent stage of n stage process can be defined by a sample source. In certain aspects, the first predetermined time in step a) of the first stage and a first predetermined time in step a) of each subsequent stage is the same or different and can be from greater than 0 to about 72 hours, including exemplary values of about 1 hour, about 6 hours, about 12 hours, about 18 hours, about 24 hours, about 36 hours, about 42 hours, about 48 hours, about 54 hours, about 60 hours, and about 66 hours. It is further understood that the first predetermined time in step a) of the first stage and a first predetermined time in step a) of each subsequent stage can have any value between any two foregoing values.

In still further aspects, the second predetermined pH in step b) of the first stage is at least 0.1, at least 0.2, at least 0.3, at least 0.4, at least 0.5, at least 0.6, at least 0.7, at least 0.8, at least 0.9, or at least 1 unit higher than the first predetermined pH in step a) of the first stage.

In still further aspects, the second predetermined period of time needed during the step of aging the first solution can be any time. In certain exemplary and unlimiting aspects, the second predetermined time in step c) of the first stage and a second predetermined time in step c) of each subsequent stage is the same or different, and it ranges from greater than 0 to about 72 hours, including exemplary values of about 1 hour, about 6 hours, about 12 hours, about 18 hours, about 24 hours, about 36 hours, about 42 hours, about 48 hours, about 54 hours, about 60 hours, and about 66 hours. It is further understood that the second predetermined time in step c) of the first stage and a second predetermined time in step c) of each subsequent stage can have any value between any two foregoing values.

In still further aspects, the first solution in steps a)-c) in the first stage and the first solution in steps a)-c) in each subsequent stage are further stirred. It is further understood that the steps a)-c) in the first stage and in each subsequent stage can be performed at room temperature. However, performing the methods’ steps at room temperature is not limiting, and the same steps can also be performed at a temperature from greater than 0° C. to about 80° C., including exemplary values of about 1° C., about 5° C., about 10° C., about 15° C., about 20° C., about 25° C., about 30° C., about 35° C., about 40° C., about 45° C., about 50° C., about 55° C., about 60° C., about 65° C., about 70° C., and about 75° C.

Any methods known in the art can be used to separate the first solid fraction from the liquid fraction. It is understood that the separation can be performed with a vacuum or without a vacuum. In yet other aspects, the separation can be performed at any temperature effective to provide efficient separation.

In still further aspects, the at least one of the one or more rare earth element salts in the first solid fraction of the first stage and a first solid fraction of each subsequent stage comprises a second quantity of the one or more rare earth elements. In still further aspects, the methods disclosed herein comprise a step of measuring the second quantity of the one or more rare earth elements at the first stage.

In still further aspects, the method steps are repeated for n times. In such aspects, a first solution in step a) of each subsequent stage is substantially similar to a first liquid fraction formed in step d) of each preceding stage. In yet further aspects, a first predetermined pH at step a) of each subsequent stage is higher than a first predetermined pH at step a) of each preceding stage. In still further aspects, a second predetermined pH in step b) of each subsequent stage is higher than the first predetermined pH at step a) of the same stage. In still further aspects, the second predetermined pH in step b) of each subsequent stage of the n stages is least 0.1, at least 0.2, at least 0.3, at least 0.4, at least 0.5, at least 0.6, at least 0.7, at least 0.8, at least 0.9, or at least 1 unit higher than the first predetermined pH in step a) of the same stage. In still further aspects, the second predetermined pH of the n^{th} stage is from about 8 to about 14, including exemplary values of about 8.5, about 9, about 9.5, about 10, about 10.5, about 11, about 12, about 12.5, about 13, and about 13.5. It is further understood that the second predetermined pH of the n^{th} stage can have any value between any two foregoing values.

In still further aspects, the second quantity of the one or more rare earth elements is measured at each subsequent stage of n stage process. In yet further aspects, a total second quantity of the one or more rare earth elements comprises a sum of each of the second quantities measured at each of n^{th} stages, and wherein the total second quantity of the one or more rare earth elements comprises at least about 70 %, at least about 75 %, at least about 80 %, at least about 85 %, at least about 90 %, at least about 95 %, at least about 99 %, or at least about 99.9 % of the first quantity of the one or more rare earth elements present in the first solution in the first stage.

It is understood that in some aspects, the percentages discussed herein can relate to weight percentages. Yet in other aspects, the percentages are used to demonstrate the disclosed properties, amounts, or quantities as a function of the initial property, quantity, or amount.

In still further aspects, at least 70 % of the total second quantity of the one or more rare earth elements is collected at a stage having a second predetermined pH from about 5 to about 8, including exemplary values of about 5.5, about 6, about 6.5, about 7, and about 7.5. In yet other aspects, at least 70 % of the total second quantity of the one or more rare earth elements is collected at a stage having a second predetermined pH from about 5 to about 8, including exemplary values of about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, and about 7.9.

In yet other exemplary aspects, in the methods disclosed herein at least about 70 %, at least about 75 %, at least about 80 %, at least about 85 %, at least about 90 %, at least about 95 %, at least about 99 %, or at least about 99.9 % of the total second quantity of the one or more rare earth elements is collected at a stage having a second predetermined pH from about 5 to about 8, including exemplary values of about 5.5, about 6, about 6.5, about 7, and about 7.5, or any other pH within this range. In yet other exemplary aspects, in the methods disclosed herein at least about 70 %, at least about 75 %, at least about 80 %, at least about 85 %, at least about 90 %, at least about 95 %, at least about 99 %, or at least about 99.9 % of the total second quantity of the one or more rare earth elements is collected at a stage having a second predetermined pH from less than about 8, including exemplary values less than about 7.5, less than about 7, less than about 6.5, less than about 6, or less than about 5.5.

In still further aspects, at least 70 % of the total second quantity of the one or more rare earth elements is collected at a stage having a second predetermined pH at least 0.5 unit lower when compared to substantially identical reference method that does not comprise step a) of treating the first solution with the reagent. For example, when a recovery % of the total second quantity of the one or more rare earth elements is measured for methods that do not comprise a step of treating the first solution in the first stage and each subsequent stage with the reagent, such as for example, carbon dioxide, the highest recovery % is obtained at pH that at least 0.5 unit higher than the recovery % obtained by the methods disclosed herein. In yet other exemplary aspects, in the methods disclosed herein at least about 70 %, at least about 75 %, at least about 80 %, at least about 85 %, at least about 90 %, at least about 95 %, at least about 99 %, or at least about 99.9 % is collected at a stage having a second predetermined pH at least 0.5 unit lower when compared to substantially identical reference method that does not comprise step a) of treating the first solution with the reagent. In still other aspects, the disclosed herein amount can be collected at a stage having a second predetermined pH of at least 0.6. at least 0.7, at least 0.8, at least 0.9, or at least 1 unit lower when compared to substantially identical reference method that does not comprise step a) of treating the first solution with the reagent.

In still further aspects, the first solid fraction in the first stage and the first solid fraction in each subsequent stage can further comprise one or more other elements. In such exemplary aspects, the one or more other elements can comprise iron, aluminum, calcium, magnesium, or manganese. It is understood that the methods disclosed herein allow the collection and separation of these elements.

In still further aspects, the methods disclosed herein can be used as the REEs recovery methods. While in other aspects, the methods disclosed herein can be used as carbon dioxide sequestration methods.

Also disclosed herein are methods comprising: a) treating a solution having a first predetermined pH and comprising a first quantity of one or more rare earth elements (REEs) and a second quantity of one or more of iron, aluminum, calcium, magnesium, or manganese with a reagent under conditions effective to form: i) a salt comprising one or more of a carbonate of one or more rare earth element, bicarbonate of one or more rare earth element, hydroxycarbonate of one or more rare earth element or a combination thereof, and ii) a precipitate of one or more of iron, aluminum, calcium, magnesium, or manganese, or a combination thereof for a first predetermined period of time to form a first liquid fraction and a first solid fraction, wherein the first solid fraction comprises the precipitate of one or more of iron, aluminum, calcium, magnesium, or manganese; b) adjusting the first predetermine pH of the solution to reach a second predetermined pH, wherein the second pH is higher than the first predetermined pH; c) aging the first solution for a second predetermined period of time at conditions effective to form a second liquid fraction and a second solid fraction, wherein the second solid fraction comprises at least one of the carbonate of one or more rare earth element, bicarbonate of one or more rare earth element, hydroxycarbonate of one or more rare earth element, or a combination thereof; and ; d) collecting the first solid fraction and the second solid fraction.

In yet further aspects, it is understood that adjusting of pH can be done with any of the disclosed above reagents. In some aspects, the pH is adjusted with a base. However, it is also understood that if pH becomes too basic and an adjustment is needed to lower the pH, such an adjustment can be done with any known in the art acid.

In yet other aspects, also disclosed is treating the disclosed herein solution with a reagent under conditions effective to form phosphate salt, dihydrogen phosphate salt, hydrogen phosphate salt, or any combinations thereof of the one or more rare earth elements. In such aspects, any of the disclosed above reagents can be utilized. It is also understood that in some aspects, the reagent can form sulfate salts of one or more rare earth elements.

In further aspects, the precipitate of one or more of aluminum, iron, calcium, magnesium, or manganese comprises a hydroxide, carbonate, bicarbonate, or a combination of thereof of the one or more of aluminum, iron, calcium, magnesium, or manganese. It is understood, however, that the conditions effective to form a specific compound can include the presence of some additional components. For example, it is understood that the base used to adjust the pH of the solution can affect the conditions effective to form a specific compound. In some exemplary and unlimiting aspects, when treating with, for example, a carbonate-containing compound designed to form at least one of carbonate or bicarbonate or hydroxycarbonate salt of one or more rare earth elements, the presence of the base in the solution, for example, sodium hydroxide can also affect what precipitate of aluminum, iron, calcium, magnesium, or manganese is formed.

In certain aspects, the first solid fraction is collected before step b). However, it is optional in some aspects, the first solid fraction and the second solid fractions can be separated at any point if desired.

Any of the disclosed above reagents can be used in these methods. In certain aspects used in this exemplary method, the reagent can be the carbon dioxide gas, the carbonate salt, the bicarbonate salt, or a combination thereof. While in other exemplary aspects, the carbonate salt and/or the bicarbonate salt are provided as a solution, as a solid, or as a combination thereof. Similarly, in some aspects, the reagent can be any of the disclosed above phosphate salts, dihydrogen phosphate salts, hydrogen phosphate salts, or sulfate salts.

In some aspects, the first pH is between 3.5 to 5.5, including exemplary values of about 4, 4.1, 4.2, 4.3, 4.4, 4.5, 4.6, 4.7, 4.8, 4.9, 5.0, 5.1, 5.2, 5.3, and about 5.4. In still further aspects, the first pH is about 5.

In still further aspects, the second pH is between 6 and 7.5, including exemplary values of about 6.1, 6.2, 6.3, 6.4, 6.5, 6.6, 6.7, 6.8, 6.9, 7.0, 7.1, 7.2, 7.3, and about 7.4. In yet further aspects, the second pH is about 7.

It is understood that any of the iron, aluminum, calcium, magnesium, or manganese, or their combination can be present in the first solid fraction. In some aspects, the first solid fraction comprises aluminum precipitate. In some aspects, the first solid fraction comprises iron precipitate. In some aspects, the first solid fraction comprises calcium precipitate. In some aspects, the first solid fraction comprises magnesium precipitate. In some aspects, the first solid fraction comprises manganese precipitate.

Yet, in other aspects, the precipitate can be aluminum carbonate, aluminum bicarbonate, aluminum hydroxycarbonate, aluminum hydroxide, or any combination thereof. Yet, in other aspects, the precipitate can be iron carbonate, iron bicarbonate, iron hydroxycarbonate, iron hydroxide, or any combination thereof. Yet, in other aspects, the precipitate can be calcium carbonate, calcium bicarbonate, calcium hydroxycarbonate, calcium hydroxide, or any combination thereof. Yet, in other aspects, the precipitate can be magnesium carbonate, magnesium bicarbonate, magnesium hydroxycarbonate, magnesium hydroxide, or any combination thereof. Yet, in other aspects, the precipitate can be manganese carbonate, manganese bicarbonate, manganese hydroxycarbonate, manganese hydroxide, or any combination thereof.

In yet further aspects, the first solid fraction can comprise at least 30 %, at least 40 %, at least 50%, at least 60%, at least 70%, at least 80 %, at least 90 % of all aluminum present in the solution. It is again understood that a similar amount of iron, calcium, magnesium, or manganese can be present in the first solid fraction. For example, the first solid fraction can comprise at least 30 %, at least 40 %, at least 50%, at least 60%, at least 70%, at least 80 %, at least 90 % of all calcium present in the solution. Yet in other exemplary aspects, the first solid fraction can comprise at least 30 %, at least 40 %, at least 50%, at least 60%, at least 70%, at least 80 %, at least 90 % of all iron present in the solution. While in still further aspects, the first solid fraction can comprise at least 30 %, at least 40 %, at least 50%, at least 60%, at least 70%, at least 80 %, at least 90 % of all magnesium present in the solution While in still further aspects, the first solid fraction can comprise at least 30 %, at least 40 %, at least 50%, at least 60%, at least 70%, at least 80 %, at least 90 % of all manganese present in the solution.

In still further aspects, the second solid fraction comprises at least 30 %, at least 35%, at least 40 %, at least 45%, at least 50%, at least 55%, at least 60%, at least 65%, at least 70%, at least 75%, at least 80 %, at least 85%, or at least 90 % of the first quantity of the one or more rare earth elements.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for.

Unless indicated otherwise, parts are parts by weight, temperature is degrees C or is at ambient temperature, and pressure is at or near atmospheric or full vacuum.

### Example 1

800 L acid mine drainage (AMD) sample was collected from the feed stream of an active AMD treatment facility operated by the Pennsylvania Department of Environmental Protection (PADEP), Pennsylvania, US. AMD sample was analyzed for elemental content using Inductivity Coupled Plasma - Mass Spectroscopy (ICP-MS) and Ion Chromatography. As shown in Table 1, the total REEs (TREEs) content of the sample was found to be 500 ppb with the pH/Eh of 3.67/184.3 (mV) and the acidity of 26038 mg/L as CaCO₃ (reported by PADEP).

Compared to the REEs content of various AMDs as a function of pH, reported in the literature, the sampled AMD of this example was found to have a slightly higher TREEs content than those reported at the same pH intervals (W. Zhang et al., “Rare earth elements recovery using staged precipitation from a leachate generated from coarse coal refuse,” International Journal of Coal Geology, vol. 195, pp. 189-199, 2018). Without wishing to be bound by any theory, the higher TREEs content of the sampled AMD was attributed to its origin from the lower Kittanning coal seam, which is known to have an elevated REEs content (S. J. Schatzel et al., “Rare earth element sources and modification in the Lower Kittanning coal bed, Pennsylvania: implications for the origin of coal mineral matter and rare earth element exposure in underground mines,” International Journal of Coal Geology, vol. 54, pp. 223-251, 2003).

TABLE 1

Elemental content of the AMD sample.

| HREE(ppbᵥ) | Y | Eu | Gd | Tb | Dy | Ho | Er | Tm | Yb | Lu | |
|---|---|---|---|---|---|---|---|---|---|---|---|
| | 157.90 | 6.29 | 38.31 | 6.36 | 34.17 | 6.85 | 19.80 | 2.26 | 12.33 | 1.80 | |
| LREE (ppbv) | Sc | La | Ce | Pr | Nd | Sm | HREE | LREE | TREE | H/L | |
| | 6.98 | 24.56 | 79.15 | 12.21 | 66.25 | 22.79 | 286 | 212 | 500 | 1.35 | |
| Major Cations (ppmᵥ) | Al | Fe | Mg | Mn | Na | Si | Co | Ni | Cu | Zn | Ca |
| | 33.73 | 0.17 | 324.06 | 33.36 | 7.88 | 18.35 | 0.72 | 1.21 | 0.04 | 2.51 | 178 |
| Major Anions (ppmᵥ) | F | Cl | SO₄2— | NO₃— | | | | | | | |
| | 1.05 | 0.76 | 2.03 | 0.11 | | | | | | | |

As discussed in detail above, REEs are classified into two general groups as light REEs (LREEs: Sc, La, Ce, Pr, Nd, Sm) and heavy REEs (HREEs: Y, Eu, Gd, Tb, Dy, Ho, Er, Tm, Yb, Lu), of which the demand for the latter is higher owing to lesser common natural occurrence. The higher ratio of heavy to light REEs (i.e., H/L) is an indication of a more viable resource. H/L ratio of the AMD studied in this example is significantly higher than those reported in the literature, e.g., eastern Kentucky Pennsylvanian coals, Russian Far East deposits with considerably high REEs content, and the AMDs from Northern and Central Appalachian Coal Basins. Without wishing to be bound by any theory, the higher H/L ratio also indicates the selective dissolution of heavy (high value) REEs in natural mine drainages.

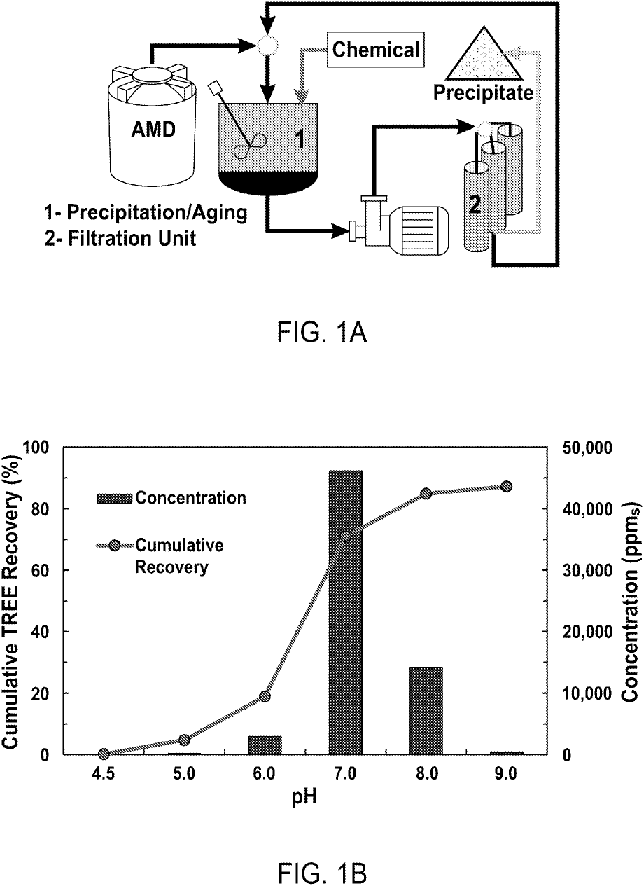

Two sets of experiments were designed for the recovery of REEs through staged precipitation. In the first set, used as the baseline (control), NaOH, which is utilized in AMD treatment of the sampled site, was used to adjust the pH. In the second set of experiments, at each step, CO₂ was purged into the solution as the carbonate source, and NaOH was used to adjust the pH. The schematic representation of the experimental setup is depicted in FIG. 1A.

For each set of experiments, a 20 L sample of the AMD was first filtered to remove coarse impurities such as algae and sands. The AMD was directly transferred to Tank-2, as shown in FIG. 1A.

NaOH (ACS grade - Sigma Aldrich) was used to prepare 2 and 5 M stock solutions for pH adjustments in both experiments. Once the pH of the solution was adjusted to a target value by the addition of NaOH, the solution was stirred at a rate slightly lower than 400 rpm for another 24 h to ensure pH is constant and the precipitation process is finished (V. Philippini et al., “Precipitation of ALn (CO3) 2, xH20 and Dy2 (CO3) 3, xH2O compounds from aqueous solutions for A+= Li+, Na+, K+, Cs+, NH4+ and Ln3+= La3+, Nd3+, Eu3+, Dy3+,” Journal of Solid State Chemistry, vol. 181, no. 9, pp. 2143-2154, 2008; J. D. Rodriguez-Blanco et al., “The Role of REE³⁺ in the crystallization of lanthanides,” MineralogicalMagazine, vol. 78, no. 6, pp. 1373-1380, 2014). During this time period, which exceeds the required reported time for REEs precipitation, the pH was monitored and adjusted as needed.

A similar time period was also used for CO₂/NaOH experiments. First, the pure CO₂ gas was purged into the 20 L AMD (open to atmosphere) for 24 h while stirring at the rate of ~400 rpm prior to each pH adjustment step. Upon each pH adjustment and stabilization, the solution was pumped to a high-pressure (700 kPa) filtration set up to collect the precipitates from the system. Hydrophilic polyvinylidene fluoride (PVDF) filters (Durapore® membrane - Millipore-Sigma) with 0.45 µm pore size was used as the filter media. The pH/Eh of the system was continuously monitored and noted for any change during the experiment. Upon filtration, the filter cake was collected and dried in a vacuum (70 kPa) oven at 70° C. for 48 h, weighed and stored sealed for further analyses, and the solution was undergone the same procedure for the next target pH, including purging the CO₂.

The AMD precipitates collected at each pH point and the final solution were analyzed for their elemental content via Thermo iCAP 7400 Inductively Coupled Plasma Emission Spectrometry (ICP-AES) and Thermo Fisher Scientific X Series 2 (ICP-MS) with detection limits of pg/L(D. Merten et al., “Determination of Rare Earth Elements in Acid Mine Drainage by Inductively Coupled Plasma Mass Spectrometry,” Microchim. Acta, vol. 148, pp. 163-170, 2004).

The precipitates were acid digested prior to ICP analyses according to ASTM standard procedure (D6357-11). The quality control for the ICP analysis was strictly implemented through several repeated experiments and a number of external standards of known concentration (NIST-1640a, PGM-1, BHVO-1, and BCR-1).

Dionex ICS-3000 ion chromatography (IC) was utilized to measure concentrations of major anions in AMD. Apreo (Thermo Fisher Scientific) Scanning Electron Microscopy (SEM) was employed to acquire the micrographs of the precipitates, and their phases and chemical composition were determined using Energy Dispersive Spectroscopy (EDS). A thin layer of precipitates was placed on a carbon tape and attached to the SEM sample holder. The samples were first coated by an iridium layer of 15 nm using Leica high vacuum sputter coater (EM ACE600). ICP data were analyzed, and the concentration of the elements for each precipitate was calculated. The recovery of elements for the precipitation experiments was reported as a mass ratio of the element in the precipitate to that in the feed (AMD), according to Eq. 6.

$$R e c o v e r y \left(\%\right) = 100 \times \frac{{C}_{p i} \times {M}_{p i}}{\left({\sum }_{4.5}^{9} {C}_{p i} \times {M}_{p i}\right) + \left({C}_{f s} \times {V}_{f s}\right)} \qquad \text{(6)}$$

where Cₚᵢ and Mₚᵢ are the concentration (mg/g) and mass (g) of the precipitates at the pHᵢ in the stage precipitation; and C_{fs} and V_{fs} are the concentration (mg/L) and volume (L) of the final solution, respectively.

### Example 2

The AMD sample was first subjected to a staged precipitation process using NaOH as described in Example 1 to provide a baseline for the precipitation behavior of elements in the solution without introducing other anions to the system other than the hydroxyl group (OH⁻).

FIG. 1B shows the recovery and concentration of TREEs in the precipitate collected at each stage where pH was adjusted by NaOH. Without wishing to be bound by any theory, at these conditions, the REE precipitates are hypothesized to be metal hydroxides, according to the Pourbaix diagrams. FIG. 1B demonstrates that when pH is adjusted with NaOH, the vast majority of REEs precipitate at pH 7-8, which is in good agreement with previous studies (W. Zhang et al., “Rare earth elements recovery using staged precipitation from a leachate generated from coarse coal refuse,” International Journal of Coal Geology, vol. 195, pp. 189-199, 2018).

It was found that at pH 7, TREEs′ concentration was 46,000 ppmₛ (4.6%). It was found that when compared to other reported results, this is the highest concentration of TREEs reported for this method (W. Zhang et al., “Rare earth elements recovery using staged precipitation from a leachate generated from coarse coal refuse,” International Journal of Coal Geology, vol. 195, pp. 189-199, 2018; G. B. Abaka-Wood et al., “Recovery of rare earth elements minerals from iron oxide-silicate rich tailings - Part 1: Magnetic separation,” Minerals Engineering, vol. 136, pp. 50-61, 2019; S. Wu et al., “Recovery of rare earth elements from phosphate rock by hydrometallurgical processes - A critical review,” Chemical Engineering Journal, vol. 335, pp. 774-800, 2018). It was found that sufficient aging time is required for the system to obtain the desired kinetics of the nucleation and the growth rate of the nuclei. If the precipitation time and conditions are not adequate and sufficient, the precipitation of elements at each step will not be completed and more likely to extend to the next precipitation stages. Therefore, the concentration of each element will be lower, and the corresponding recovery pH interval will be wider. It was found that if the recovery method is conducted without 24 h aging time, only ~40% of REEs were recovered. The data in FIG. 1B show that, in certain aspects, only 70% of the TREEs can be recovered at pH 7 at the AMD treatment facilities.

Since the AMD also can contain other metal elements, the recovery of those elements was measured. The cumulative recovery of the Al and Fe was found to be around 70% at pH 7. Considering the fact that the Fe content of the feed is not significant (250 ppbᵥ), the major impurity in the precipitates was found to be Al, which accounts for between 20-30 wt.% of the precipitates in all stages up to pH 7. The concentration of Fe, on the other hand, never exceeded 1%, even at the highest recovery stages.

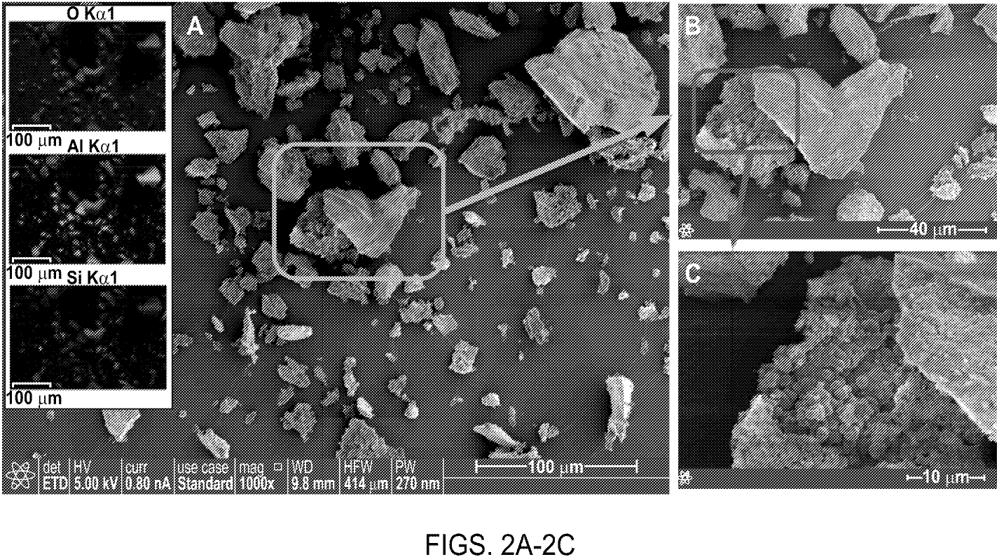

FIG. 2 depicts the morphology of the precipitates obtained with the use of NaOH as a pH adjusting solution at pH 7. SEM micrographs and the EDS analyses (FIG. 2A inserts) showed that the nodular gibbsite (Al(OH)₃) is the major formation at pH 7. Along with gibbsite (FIG. 2C), rare Fe and Mn complexes were also observed.

As for REEs, no distinguishable formations were observed in precipitates even at the product with the highest concentration. It was found that in more acidic and sulfate rich AMD, iron mostly precipitates as jarosite. Once the system becomes more diluted or neutralized, more pure Fe formations such as goethite are formed. As for REE, no distinguishable formations were observed in precipitates, even at the product with the highest concentration.

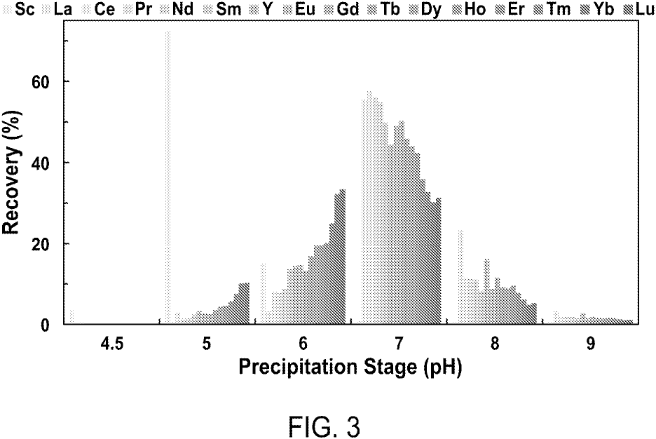

The distribution of the individual REE recovery in precipitate products is shown in FIG. 3. No distinct differentiation was observed for the individual REE recovery at various pH values. It was also found that these individual elements generally demonstrate similar patterns and behavior. Without wishing to be bound by any theory, it was hypothesized that this behavior is due to the molecular bonding structure of the lanthanides: although each new electron in the series fills the 4f orbital, still 5d and 6 s orbitals have a major contribution to the bonding of lanthanides, which remains almost unchanged in the series (L.-M. Li et al., “INDO Studies on the electronic structure of lanthanoid compounds,” International Journal of Quantum Chemistry, vol. 23, no. 4, pp. 1305-1316, 1983). However, some slight fractionations within the series were observed at pH 4.5 to 7. It was found that the heavier elements (i.e., Er, Tm, Yb, and Lu) show a tendency to precipitate at lower pH (5-7), while lighter ones (i.e., La, Ce, and Pr) precipitate at higher pH (7-8). Again, without wishing to be bound by any theory, this fractionation was explained by the difference in Kₛₚ of lanthanides, which is the consequence of “lanthanide contraction.” (S. P. Cooper et al., “The radiochemistry of the rare earths: scandium, yttrium, and actinium,” National Academies, vol. 3020, 1961.)

By increasing the atomic number in lanthanides, the attraction force exerted on the electrons in the outermost shell increases. This force is, to some extent, compensated by the addition of electrons. However, since the new electron will fill the 4f orbital of the lanthanides, its screening effect is much lower (about 0.85). This phenomenon causes a shrinkage in the atomic (and ionic) radius of lanthanides as the atomic number increases, which is known as lanthanide contraction. It should be mentioned that although yttrium is lighter than the lanthanides, it is often categorized with the HREEs since its ionic radius (Y³⁺) falls between Ho³⁺ and Er³⁺, while its atomic radius is between Nd and Sm (C. Huang, Rare Earth Coordination Chemistry: Fundamentals and Applications, Singapore: John Wiley & Sons (Asia) Pte Ltd, 2011). As a result, the chemical and physical properties of yttrium are similar to those of HREEs.

Water molecules surround the immersed metal ions due to the electrostatic interaction between the positively charged metal ion and the partially negative oxygen atom of water molecules, resulting in the hydration of metal ions. Hydrated metals undergo through hydrolysis process and form hydroxo metal complexes, continuous of which results in polymerization and precipitation of the metals. The number of water molecules surrounding the metal ions (i.e., coordination number) and the hydration energy are major contributing factors in the further precipitation of the metals. Although the coordination number for trivalent metals is generally 6, it varies between 8 to 9 for lanthanides, which results in a tricapped trigonal prism structure for the hydrated lanthanide atoms. A general expectation is that by increasing the ionic radius of metals, the enthalpy of hydration decreases (more negative), so does the Gibbs free energy of hydration, which makes the hydration more favorable. However, due to the contraction, the coordination number of lanthanides decreases by increasing the atomic number owing to a weaker M-O bond, resulting in lower surrounding water molecules and an increase in hydration enthalpy (less negative).

Based on the reduction in the number of surrounding water molecules, the lanthanides can be classified into four tetrads. A parameter defined as Effective Precipitation pH (pH_{EP}) as a sum-product of pH value and the corresponding REEs recovery was used to define the behavior of REEs in the aqueous solutions as a function of hydration tetrads (Eq. 7).

$$p {H}_{E P} = \sum p {H}_{S t a g e i} \times R e c o v e r {y}_{S t a g e i} \qquad \text{(7)}$$

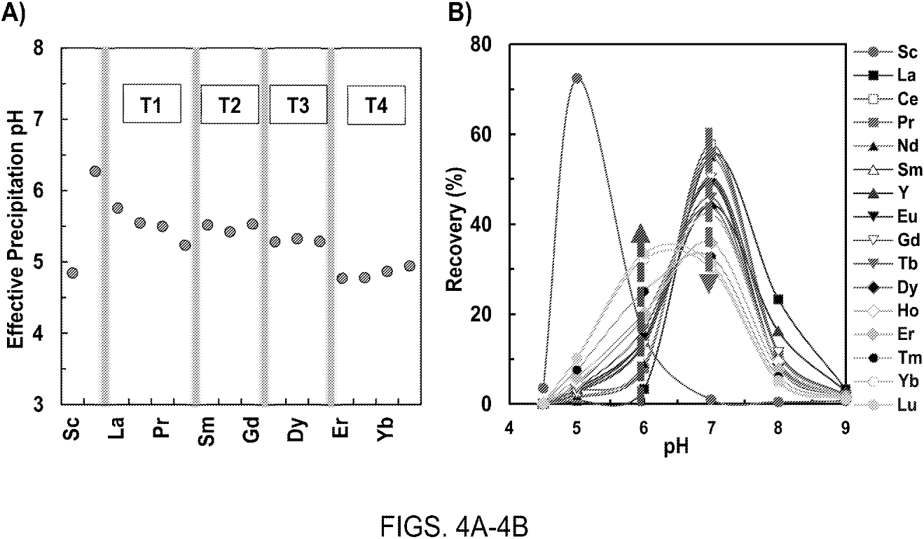

It was found that the pH_{EP} of REEs (Table 2) follows the hydration tetrads of the lanthanides, as shown in FIG. 4A. An approach to classify REEs precipitation behavior in aqueous solutions based on the tetrads of coordination number and M-O bond strength was attempted. Without wishing to be bound by any theory, it was assumed that based on the tetrad classification, higher tetrad lanthanides can undergo hydration and hydrolysis at lower pH and consequently polymerize and precipitate earlier. The tetrad effect has also been discerned in the solubility constant of REEs with EDTA complexes (I. Persson, P. D′Angelo, S. De Panfilis, M. Sandström and L. Eriksson, “Hydration of Lanthanoid(III) Ions in Aqueous Solution and Crystalline Hydrates Studied by EXAFS Spectroscopy and Crystallography: The Myth of the “Gadolinium Break,” Chemistry: A European Journal, vol. 14, no. 10, pp. 3056-3066, 2008).

From the recovery of individual REE at various pH values (FIG. 4B), it can be seen that with the increasing atomic number of lanthanides, the precipitation (i.e., recovery) at pH 7 decreases (red arrow), while it increases at pH 5-6 (green arrow). Again, without wishing to be bound by any theory, it was found, however, that the shift in the recovery % coincides well with tetrad classification and the change in the M-O bond strength as a function of ion radius.

### Example 3

Table 3 shows a comparison of the Gibbs free energy of formation (ΔG°_{f}) for both carbonate and hydroxide species of REEs. Table 4 shows Kₛₚ data.

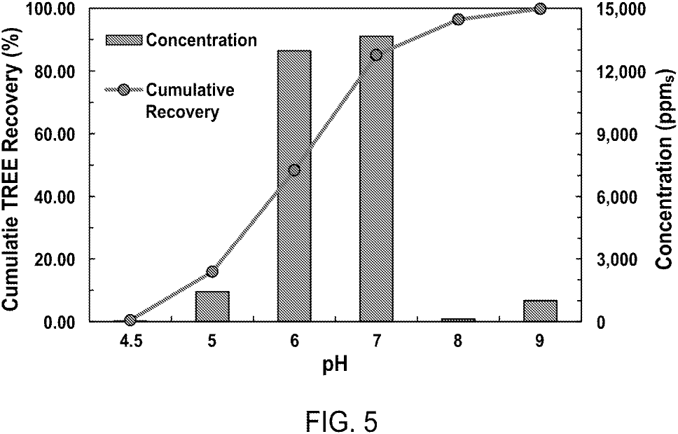

The AMD samples were prepared accordingly to Example 1 and were treated with CO₂ gas followed by the pH adjustment with NaOH. The recovery and concentration of REEs in precipitates at various pH with CO₂/NaOH are shown in FIG. 5. When CO₂ was purged into the solution prior to the addition of NaOH, the precipitation pH of REEs in general shift roughly to one pH point lower, compared to those of NaOH (FIG. 1B). The Gibbs free energy of the REE-carbonates is, on average, 10⁵-10¹³ times lower than that of REE hydroxides, which results in significantly lower solubility of REE-carbonates. From the limited available data on REE-hydroxycarbonates, it can be seen that the solubility of the REE-hydroxycarbonates falls between those of REE-carbonates and -hydroxides, so should be the precipitation pH. When CO₂ was used, the cumulative TREEs recovery increased to more than 85% (which is about 10% higher than that of NaOH) at pH 7. It is understood that these results represent opportunities that previously were not so available since increasing the target pH to increase the recovery of TREEs is not a viable solution due to the chemical cost and potential environmental concerns.

TABLE 2

| Ele,emts | Recovery and pH_{EP} of lanthanides at various stages | | | | | | | | | | | | | |
|---|---|---|---|---|---|---|---|---|---|---|---|---|---|---|
| | NaOH | | | | | | | CO₂/NaOH | | | | | | |
| | Recovery at pH (%) | | | | | | pH_{E} P | Recovery at pH (%) | | | | | | pH_{E} P |
| | 4.5 | 5 | 6 | 7 | 8 | 9 | | 4.5 | 5 | 6 | 7 | 8 | 9 | |
| Sc | 3.4 7 | 72.4 1 | 15.0 5 | 0.95 | 0.47 | 0.6 7 | 4.8 4 | 14.9 3 | 46.4 6 | 11.1 8 | 7.50 | 4.02 | 0.3 1 | 4.54 |
| Y | 0.0 6 | 0.67 | 3.37 | 55.4 4 | 23.2 3 | 3.2 8 | 6.2 7 | 0.24 | 7.43 | 24.8 7 | 62.1 7 | 8.93 | 2.3 9 | 7.16 |
| La | 0.3 3 | 2.94 | 8.03 | 57.6 7 | 11.4 4 | 1.7 6 | 5.7 5 | 0.46 | 11.6 6 | 36.9 3 | 46.8 5 | 6.38 | 1.8 8 | 6.78 |
| Ce | 0.0 7 | 1.37 | 7.86 | 56.0 9 | 11.2 6 | 1.9 4 | 5.5 4 | 0.21 | 13.0 7 | 32.3 6 | 40.6 3 | 10.8 4 | 3.2 3 | 6.61 |
| Pr | 0.0 7 | 1.56 | 8.78 | 54.8 0 | 11.0 4 | 1.8 9 | 5.5 0 | 0.21 | 14.5 0 | 36.3 1 | 40.6 3 | 11.6 9 | 3.6 5 | 7.02 |
| Nd | 0.0 8 | 2.41 | 13.6 1 | 49.8 1 | 8.33 | 1.5 6 | 5.2 3 | 0.22 | 16.7 8 | 35.8 7 | 30.9 9 | 9.50 | 3.3 5 | 6.23 |
| Sm | 0.0 8 | 3.27 | 14.4 4 | 44.3 4 | 16.1 3 | 1.0 0 | 5.5 2 | 0.21 | 17.4 0 | 32.1 2 | 38.2 2 | 17.2 0 | 4.9 4 | 7.30 |
| Eu | 0.0 7 | 2.68 | 14.6 0 | 49.0 7 | 8.78 | 3.0 0 | 5.4 2 | 0.24 | 17.8 7 | 38.2 6 | 30.7 9 | 10.1 9 | 3.5 5 | 6.49 |
| Gd | 0.0 7 | 2.50 | 13.1 7 | 50.2 9 | 11.5 3 | 1.8 7 | 5.5 3 | 0.20 | 16.2 7 | 35.7 3 | 34.8 5 | 10.9 8 | 3.7 2 | 6.62 |
| Tb | 0.0 8 | 3.48 | 16.7 7 | 45.9 4 | 9.23 | 1.5 9 | 5.2 8 | 0.22 | 16.4 5 | 32.1 5 | 27.5 7 | 8.94 | 2.9 8 | 5.67 |
| Dy | 0.0 9 | 4.37 | 19.6 0 | 43.9 7 | 8.89 | 1.5 1 | 5.3 2 | 0.26 | 18.4 3 | 35.1 6 | 29.1 1 | 9.86 | 3.1 9 | 6.16 |
| Ho | 0.0 9 | 4.64 | 19.5 6 | 42.4 2 | 9.53 | 1.6 2 | 5.2 9 | 0.24 | 16.7 7 | 30.7 9 | 26.0 6 | 9.06 | 2.8 9 | 5.51 |
| Er | 0.1 1 | 5.72 | 20.1 2 | 35.8 9 | 7.79 | 1.5 3 | 4.7 7 | 0.25 | 16.1 9 | 28.4 7 | 21.2 8 | 7.99 | 2.5 3 | 4.89 |
| Tm | 0.1 2 | 7.54 | 25.0 1 | 32.7 4 | 6.13 | 1.2 5 | 4.7 8 | 0.37 | 20.0 7 | 33.9 7 | 23.0 1 | 8.13 | 2.4 3 | 5.54 |
| Yb | 0.1 5 | 10.0 9 | 32.1 9 | 30.2 1 | 2.36 | 1.3 0 | 4.8 6 | 0.46 | 21.9 3 | 32.0 9 | 18.2 7 | 6.36 | 1.8 6 | 5.00 |
| Lu | 0.1 7 | 10.2 4 | 33.4 8 | 30.2 9 | 2.20 | 1.3 0 | 4.9 4 | 0.50 | 22.0 7 | 34.5 4 | 18.9 1 | 6.84 | 1.8 3 | 5.23 |

TABLE 3

Thermodynamic data for various species of REEs^{a,b,c}.

| Species | ΔG°_{f} (kJ/mol) | Species | ΔG°_{f} (kJ/mol) |
|---|---|---|---|
| Sc³⁺ (aq) | -586.6 | Tm₂(CO₃)₃ (aq) | -2923.414 |
| Y³⁺ (aq) | -693.7 | Yb₂(CO₃)₃ (aq) | -2871.523 |
| La³⁺ (aq) | -683.7 | LuCO3⁺ (aq) Lu₂(CO₃)₃ (aq) | -1153.043 -3269.459 |
| Ce³⁺ (aq) | -672.0 | Sc₂(CO₃)₃ (aq) | -2750.489 |
| Pr³⁺ (aq) | -679.1 | Y₂(CO₃)₃ (aq) | -2959.848 |
| Nd³⁺ (aq) | -671.5 | La₂(CO₃)₃ (aq) | -2948.430 |
| Sm³⁺ (aq) | -666.5 | Ce₂(CO₃)₃ (aq) Ce₂CO₃ (aq) CeCO₃⁺ (aq) | -2933.109 -1728.622 -1150.946 |
| Eu³⁺ (aq) | -574.0 | Pr₂(CO₃)₃ (aq) PrCO₃⁺ (aq) | -2938.832 -1155.569 |
| Gd³⁺ (aq) | -661.0 | Nd₂(CO₃)₃ (aq) NdCO₃⁺ (aq) | -2923.278 -1148.380 |
| Tb³⁺ (aq) | -651.9 | Sm2(CO3)3 (aq) SmCO₃⁺ (aq) SmCO₃² (aq) | -2906.275 -1144.179 -1163.660 |
| Dy³⁺ (aq) | -665.0 | Eu₂(CO₃)₃ (aq) EuCO₃⁺ (aq) | -2738.310 -1050.758 |
| Ho³⁺ (aq) | -673.7 | Gd₂(CO₃)₃ (aq) GdCO₃⁺ (aq) | -2901.380 -1141.823 |
| Er³⁺ (aq) | -669.1 | Tb2(CO3)3 (aq) TbCO₃⁺ (aq) | -2911.140 -1144.624 |
| Tm³⁺ (aq) | -661.9 | Dy₂(CO₃)₃ (aq) DyCO₃⁺ (aq) | -2904.827 -1141.129 |
| Yb³⁺ (aq) | -643.9 | Ho₂(CO₃)₃ (aq) HoCO₃ (aq) | -2954.7233 -1152.942 |
| Lu⁺ (aq) | -628.0 | Er₂(CO₃)₃ (aq) CeCO₃ (aq) | -2923.760 -1147.014 |
| Sc₂O₃ (aq) | -1819.41 | Sc(OH)²⁺ (aq) | -801.2 |
| Y₂O₃ (aq) | -1816.65 | Y(OH)²⁺ (aq) Y(OH)₃ (aq) | -878.334 -1160.430 |
| La₂O₃ (aq) | -1705.8 | La(OH)²⁺ (aq) La(OH)₃ (aq) | -876.648 -1154.721 |
| Ce₂O₃ (aq) | -1706.2 | Ce(OH)²⁺ (aq) Ce(OH)³⁺ (aq) Ce(OH)₂²⁺ (aq) Ce(OH)₃ (aq) Ce(OH)₄ (aq) | -877.010 -748.225 -938.262 -1147.060 -1135.659 |
| Pr₂O₃ (aq) | -1720.875 | Pr(OH)²⁺ (aq) Pr(OH)₃ (aq) | -872.72 -1149.922 |
| Nd₂O₃ (aq) | -1720.9 | Nd(OH)²⁺ (aq) Nd(OH)₃ (aq) | -865.236 -1143.233 |
| Sm₂O₃ (aq) | -1734.7 | Sm(OH)²⁺ (aq) Sm(OH)₂ (aq) Sm(OH)₃ (aq) | -859.952 -831.724 -1133.643 |
| Eu₂O₃ (aq) | -1556.9 | Eu(OH)²⁺ (aq) Eu(OH)₂ (aq) Eu(OH)₃ (aq) | -768.973 -850.109 -1049.661 |
| Gd₂O₃ (aq) | -1730 | Gd(OH)²⁺ (aq) Gd(OH)₃ (aq) | -857.846 -1131.196 |
| Tb₂O₃ (aq) | -1774.45 | Tb(OH)²⁺ (aq) Tb(OH)₃ (aq) | -862.114 -1136.075 |
| Dy₂O₃ (aq) | -1171.5 | Dy(OH)²⁺ (aq) Dy(OH)₃ (aq) | -858.789 -1132.919 |
| Ho₂O₃ (aq) | -1791.2 | Ho(OH)²⁺ (aq) Ho(OH)₃ (aq) | -870.727 -1157.872 |

^{a}-E. Kim and K. Osseo-Asare, “Aqueous stability of thorium and rare earth metals in monazite hydrometallurgy: Eh-pH diagrams for the systems Th-, Ce-, La-, Nd-(PO4)-(SO4)-H20 at 25° C.,” Hydrometallurgy, Vols. 113-114, pp. 67-78, 2012
^{b-}J. A. Dean, Lange’s Handbook of Chemistry, Fifteenth ed., New York: McGraw-Hill, Inc., 1999.
^{c-}C. F. Baes and R. E. Mesmer, The Hydrolysis of Cations, New York: Wiley, 1976.

TABLE 4

Kₛₚ of the carbonate and hydroxide compounds of the REEs.

| REE Element | REE(OH)₃ | | REE₂(CO₃)₃ | | REE(OH)CO₃ | |
|---|---|---|---|---|---|---|
| | Log Kₛₚ | Kₛₚ | Log Kₛₚ | Kₛₚ | Log Kₛₚ | Kₛₚ |
| Sc^{a} | -28 | 1.00E-28 | -35.8 | 1.58E-36 | -- | -- |
| Y | -24.5 | 3.16E-25 | -32.8 | 1.58E-33 | -- | -- |
| La | -21.7 | 2.00E-22 | -35.3 | 5.01E-36 | -- | --- |
| Ce | -22.1 | 7.94E-23 | -35.1 | 7.94E-36 | -- | -- |
| Pr | -22.4 | 3.98E-23 | -34.8 | 1.58E-35 | -- | -- |
| Nd | -23.9 | 1.26E-24 | -34.65 | 2.24E-35 | -21.5 | 3.16E-22 |
| Sm | -25.5 | 3.16E-26 | -34.5 | 3.16E-35 | -- | -- |
| Eu | -26.9 | 1.26E-27 | -35 | 1.00E-35 | -21.8 | 1.58E-22 |
| Gd^{b} | -26.4 | 3.98E-27 | -34.7 | 2.00E-35 | -- | -- |
| Tb | -26.3 | 5.01E-27 | -34.2 | 6.31E-35 | -- | -- |
| Dy | -26.1 | 7.94E-27 | -34 | 1.00E-34 | -- | -- |
| Ho | -26.6 | 2.51E-27 | -33.8 | 1.58E-34 | -- | -- |
| Er | -27 | 1.00E-27 | -33.6 | 2.51E-34 | -- | -- |
| Tm | -27 | 1.00E-27 | -33.4 | 3.98E-34 | -- | -- |
| Yb | -27.3 | 5.01E-28 | -33.3 | 5.01E-34 | -- | -- |
| Lu | -27.5 | 3.16E-28 | -33 | 1.00E-33 | -- | -- |

^{a}-F. H. Firsching and J. Mohammadzadei, “Solubility products of the rare-earth carbonates,” Journal of Chemical & Engineering Data, vol. 31, no. 1, pp. 40-42, 1986 ^{b-}K. Spahiu and J. Bruno, “A selected thermodynamic database for REE to be used in HLNW performance assessment exercises. No. SKB-TR--95-35,” Swedish Nuclear Fuel and Waste Management Co., Cerdanyola, Spain, 1995.

However, the TREEs concentration in precipitates was found to be lower than that in the absence of CO₂. Without wishing to be bound by any theory, it was assumed that it could be due to the fact that the molecular weight of REE carbonates is higher than that of hydroxides. The REE formations in the case of NaOH are likely to be REE₂(OH)₃, while REE(OH)CO₃ and REE₂(CO₃)₃ formations are most likely obtained when CO₂ is used. Consequently, for a given system, where the amount of REEs is constant, the concentration of REEs in precipitates will be considerably lower due to the heavier component structures.

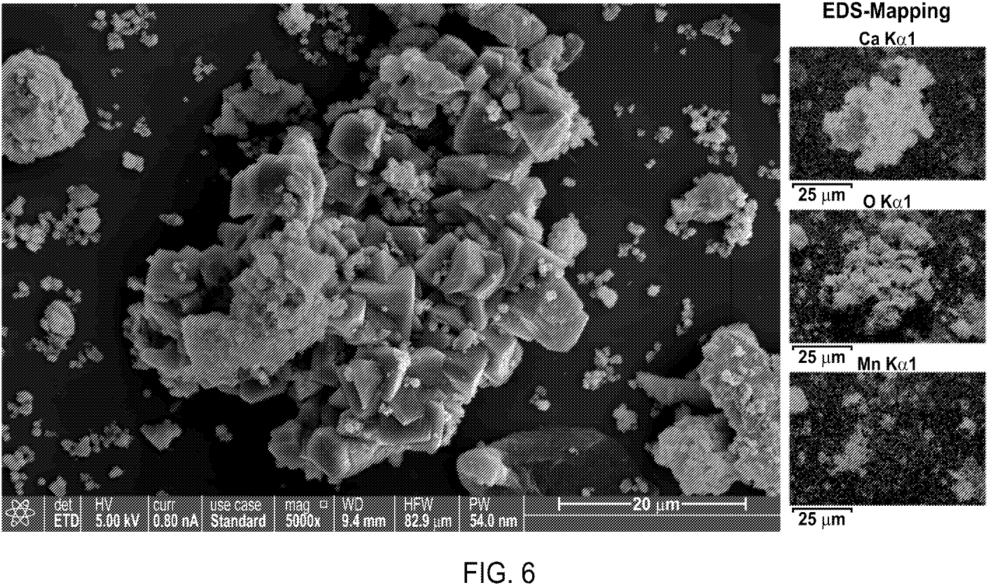

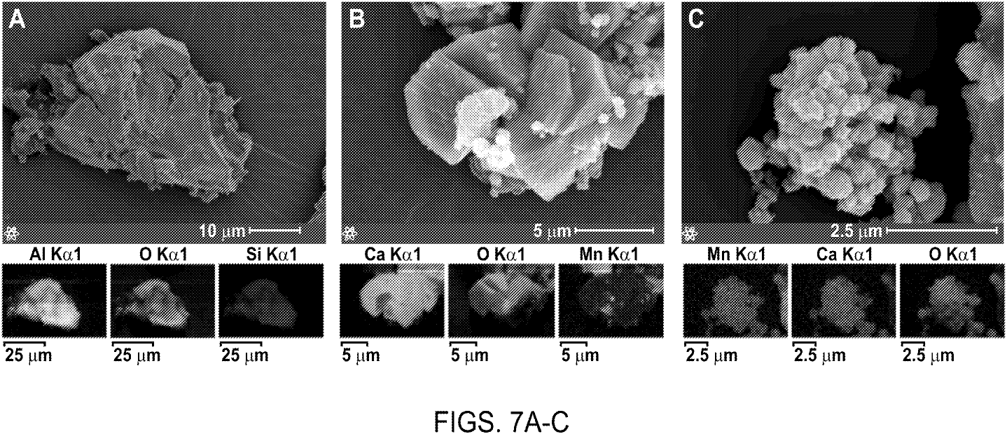

The analysis of the formations in the CO₂/NaOH precipitates at pH 7 using SEM-EDS (as shown in FIG. 6) revealed that they were mainly consisted of Ca and Mn complexes. Precipitates also showed more developed crystalline structures with well distinctive cleavages. Although the recovery of Al was increased from 65% to almost 100% with purging CO₂ into the solution, no aluminum carbonate formations were observed in the micrographs. The Al, instead, was found to precipitate with Si, perhaps as amorphous aluminum silicate, as shown in FIG. 7A.

In general, tracking the precipitation trend of Al is important as there is a possibility that trace elements and REEs can coprecipitate with Al formations. However, the results obtained herein showed that the use of neither NaOH nor CO₂/NaOH resulted in coprecipitation of trace elements with Al. The trend for the Al precipitation, as shown herein, remained the same for both NaOH and CO₂/NaOH treatments, while its recovery increased significantly when using CO₂.

However, it was also found that the REEs′ recovery pattern shifted to lower pH; hence, REEs precipitation does not follow the Al precipitation pattern. Coprecipitation of the REE with Al precipitates is unlikely, as the surface charge of the Al precipitates at the acidic pH is notably high. Without wishing to be bound by any theory, it was assumed that since the zeta potential of the Al precipitates as AI(OH)₃ is around +20 mV at pH 7 (J. Rosenqvist et al., “Protonation and Charging of Nanosized Gibbsite (r-Al(OH)3) Particles in Aqueous Suspension,” Langmuir, vol. 18, no. 12, pp. 4598-4604, 2002), a strong electrostatic repulsion against any REE ions or formations in the solution most likely to occur.

Furthermore, coprecipitation may happen when fine nuclei of REEs start to form but lack the anticipated aggregation to grow and form bigger particles to settle. In this case, the submicron (and in some cases nano) particles of REEs can adsorb on the surface of coarser precipitates and settle with them. The isoelectric point (iₑₚ) for the Al precipitates was reported as pH 9 (J. Rosenqvist et al., “Protonation and Charging of Nanosized Gibbsite (r-Al(OH)3) Particles in Aqueous Suspension,” Langmuir, vol. 18, no. 12, pp. 4598-4604, 2002). The iₑₚ of yttrium carbonate hydroxide was reported to be around pH 8 (R. Sprycha, et al., “Zeta Potential and Surface Charge of Monodispersed Colloidal Yttrium(III) Oxide and Basic Carbonate,” Journal q/’Colloid and Inter’lace Science, vol. 149, no. 2, pp. 561-568, 1992) and that of REE-carbonates to be in the range of pH 6 to 7 (G. Galt, “Adsorption of salicylhydroxamic acid on selected rare earth oxides and carbonates,” in Graduate Theses & Non-Theses. 124, Montana Tech, 2017). At pH 7, the REEs precipitates are very close to their iₑₚ, which eliminates the strong electrostatic repulsion between the REEs and Al precipitates. Without wishing to be bound by any theory, the fact that no REEs complexes were observed even in the products with the highest REEs concentration supports the hypothesis that the REEs precipitates may be disseminated as submicron particles throughout other formations but not necessarily follow the precipitation pattern of a particular host mineral. FIGS. 7B-7C show the Ca and Mn formations in precipitates, respectively, which were found as major formations in precipitates when CO₂ was used. As evident from the micrograph, no REE minerals or formations were observed on or along with these precipitates.

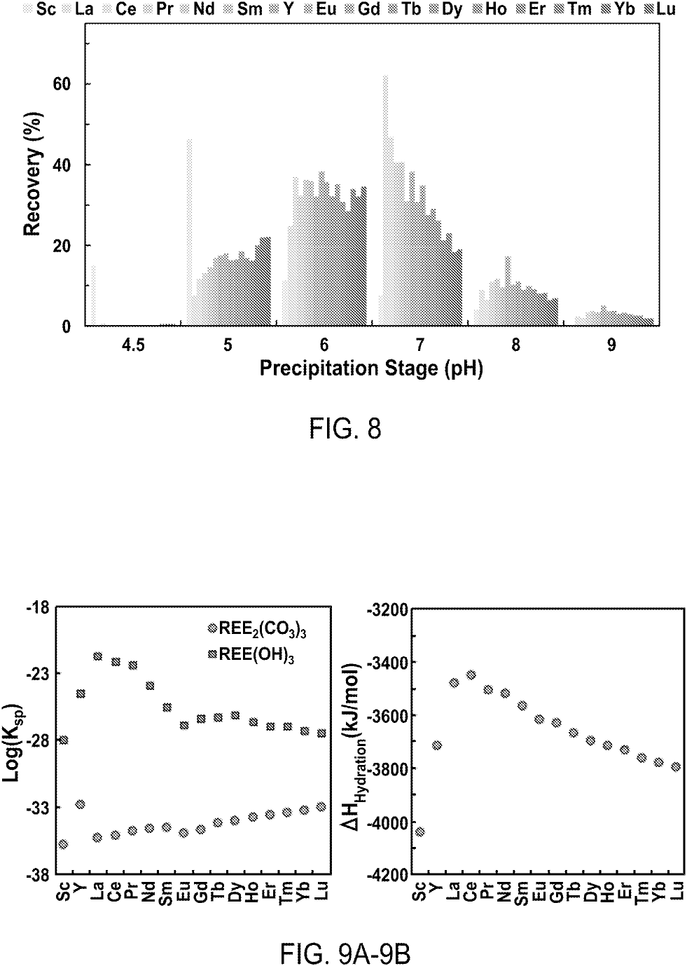

The distribution of the recovery of individual REE in CO₂/NaOH precipitation as a function of precipitation pH (FIG. 8) has shown less fractionation between LREEs and HREEs than that in NaOH precipitation. Without wishing to be bound by any theory, it was assumed that the change in the pattern of REE precipitations is due to the lower Kₛₚ for REE-carbonate than that of REE-hydroxides (FIG. 9A) (H. Firsching et al., “Solubility products of the rare-earth carbonates,” Journal of Chemical & Engineering Data, vol. 31, no. 1, pp. 40-42, 1986; K. Spahiu et al., “A selected thermodynamic database for REE to be used in HLNW performance assessment exercises. No. SKB-TR--95-35,” Swedish Nuclear Fuel and Waste Management Co., Cerdanyola, Spain, 1995).

It should be noted that the change in Kₛₚ for the LREEs is more than that in HREEs. FIG. 9A shows the difference in the solubility product of the two REEs formations as well as the different patterns of solubility in terms of LREEs and HREEs. Without wishing to be bound by any theory, it was hypothesized that the change in the precipitation pattern due to the presence of the carbonate ions seems to compensate for the difference in the precipitation of individual REE caused by the tetrads discussed in the previous section (FIG. 4).

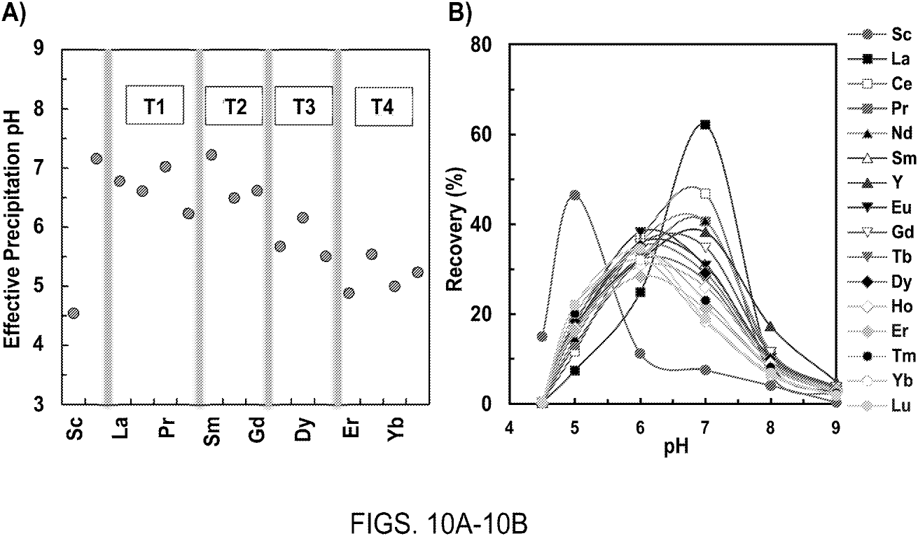

FIG. 9B shows the enthalpy of hydration for various REEs. The hydration is an exothermic reaction, which increases with increasing charge density of the element (i.e., increasing atomic number and/or reducing atomic radius). The enthalpy of hydration also increases by decreasing the M-O bond distance. The general trend for the change in enthalpy of hydration as a function of charge density and M-O bond distance has been suggested to follow the Eq. 8 (I. Persson, “Hydrated metal ions in aqueous solution: How regular are their structures? “ Pure Appl. Chem., vol. 82, no. 10, pp. 1901-1917, 2010):

$$\text{Δ} {H}_{H y d r a t i o n} \left(\text{kJ} / \text{mol}\right) = \frac{{z}^{2}}{{d}_{M - O}} \qquad \text{(8)}$$

Where Z is the charge of the ion, and the dm-o is the M-O bond distance (Å). The enthalpy of hydration data was driven from the REE-O bond distance and calculated by Eq. 7, as shown in FIG. 9B. Due to the very close ionic radius, the enthalpy of hydration for the Y is very close to that of Ho, and thus the Y ion shows very similar precipitation behavior to that of HREEs. On the other hand, the heat of hydration of Sc was found to be higher than the other REE, which can explain the unique trend of precipitation for the Sc (FIG. 4 and FIG. 10).

Effective precipitation pH of REEs when CO₂/NaOH was used (FIG. 10) shows the shift in the precipitation of REEs as REE-carbonates. Although previously it was shown that the coordination number can play a significant role in the precipitation patterns of the REE-hydroxides, this conclusion cannot be drawn for the REE-carbonate precipitation (FIG. 10A). The coordination number of REE in the hydrated REE-carbonates is 10 (S. M. Morrison et al., “Lanthanite-(Nd), Nd2(CO3)38H20,” Acta Crystallographica Section E, vol. E69, pp. i15-i16, 2013). As the tetrad classification indicated, the 10 coordinated REE is expected to show behavior close to the T1 class. However, the hydration enthalpy also plays a significant role in replacing the water molecules surrounding the REE ions for the carbonate ions to form REE-carbonates. The general trend in the effective precipitation pH of REE-carbonates does not show a clear classification based on tetrads (Table 2) but more likely to follow the hydration energy trend instead (FIG. 10A and FIG. 9B). Hydration enthalpies of REEs are large and even increase with an increasing charge density of the elements, resulting in much higher hydration energy for HREEs. Consequently, the ligand to proceed with the complexation in the solution has to overcome this energy barrier to form another stable REE-complex (REE-carbonate in this case) (J.-C. G. Bünzli, “Review: Lanthanide coordination chemistry: from old concepts to coordination polymers,” Journal of Coordination Chemistry, vol. 67, no. 23-24, pp. 3706-3733, 2014). Without wishing to be bound by any theory, this fact can be used to explain why the carbonate ions were more effective in forming REE-carbonates with LREEs, compared with HREEs, and why the solubility of the LREE-carbonates is lower than that of HREE-carbonates as reported in the literature (P. Kim et al., “Trends in Structure and Thermodynamic Properties of Normal Rare Earth Carbonates and Rare Earth Hydroxycarbonates,” Minerals, vol. 8, no. 3, p. 106, 2018). The overall trend of REE-carbonate precipitation shows that the LREEs precipitation tends to shift towards the lower pH while the change in HREEs precipitation pH is relatively small (FIG. 10B). Again, without wishing to be bound by any theory, it was hypothesized that the similar precipitation pattern among REEs when CO₂/NaOH was used is due to the fact that the REE-carbonate precipitates have 10-coordinated REE, regardless of the elements.

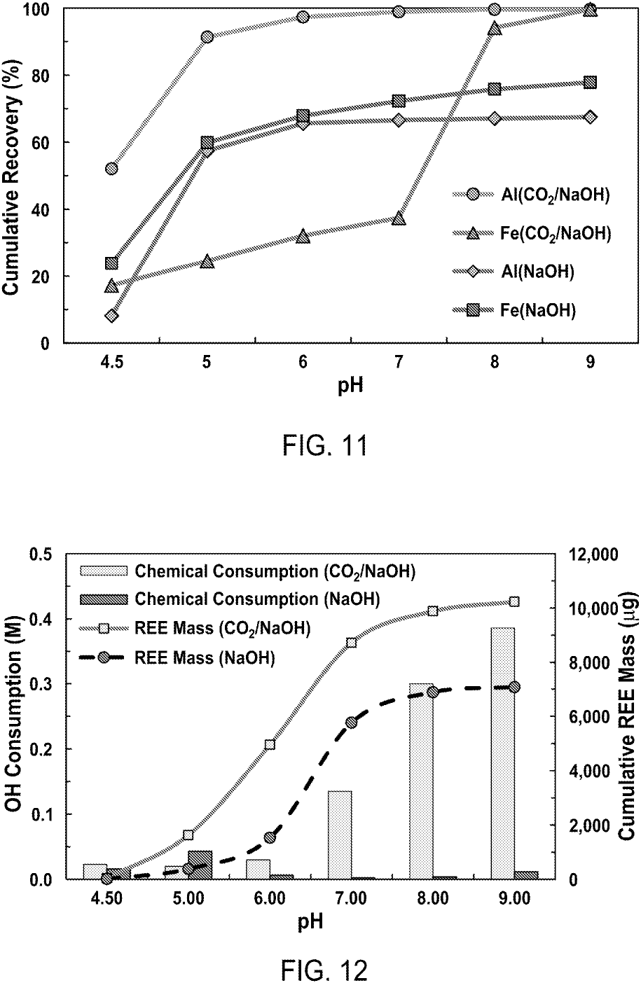

The trends of recovery and concentration of Al and Fe in both experiments were also studied as the former was the major element in the precipitates, and the latter is of importance in downstream purification processes (FIG. 11). Fe precipitation pattern with NaOH was found to be very close and even overlap with that of REEs. However, when using CO₂, the Fe precipitation was depressed up to pH 7, and the recovery of Al was increased at pH 5 (FIG. 11). Without wishing to be bound by any theory, the Fe precipitation behavior in the presence of CO₂ is assumed to be influenced by the fact that the formation of FeCO₃ decreases by increasing partial pressure of CO₂ (S. Arumugam, et al., “Modeling the influence of iron carbonate scale morphology in sweet corrosion prediction,” in CORROSION, San Antonio, 2014; R. Barker et al., “A review of iron carbonate (FeCO₃) formation in the oil and gas industry,” Corrosion Science, vol. 142, pp. 312-341, 2018). Again, without wishing to be bound by any theory, it was hypothesized that the precipitation of iron in the CO₂/NaOH system that occurs after pH 7 is because the concentration of carbonate ion starts to increase in the solution after this pH. These findings provide an opportunity to develop a two-step staged precipitation process using CO₂/NaOH for recovery of Al and REEs from aqueous systems while minimizing the Fe contamination in the product streams. At the first step of this process, 90% of Al precipitates at pH 5, then over 85% of REEs can be recovered at pH 7 while depressing and rejecting most of Fe (65%). The process can also be applied for the recovery of critical elements from other low concentration pregnant leach solutions.

### Example 4

The hydroxide consumption in the two experiments was also measured. FIG. 12 shows the comparison of hydroxide consumption when NaOH or CO₂/NaOH are used. It can be seen that the major increase in NaOH consumption starts at pH 7 and continues to increase at higher pH stages for both scenarios. When CO₂ is purged into the solution, it starts to dissolve and form various carbonate species as a function of solution pH. As pH increases, the hydroxide ions can be consumed by both the formation of precipitate complexes and carbonate species transformation in the solution. This will increase the NaOH consumption when using CO₂. However, with increasing NaOH consumption, the cumulative REEs recovery also increases. Moreover, the considerable increase in NaOH consumption occurred at higher pH values, which are higher than the target pH for AMD treatment. Without wishing to be bound by any theory, the notably higher hydroxide consumption after pH 7 when using CO₂/NaOH can be attributed to the fact that bicarbonate ions consume hydroxyl groups to form carbonate ions (i.e., the backward reaction of Eq. 4). Also, without wishing to be bound by any theory, it has been suggested that even in equilibrium, CO₂ nanobubbles still exist in saturated solutions even though they cannot dissolve in the solution (B. Vaziri Hassas et al., “Attachment, Coalescence, and Spreading of Carbon Dioxide Nanobubbles at Pyrite Surfaces,” Langmuir, vol. 34, no. 47, pp. 14317-14327, 2019). Upon metal-carbonate precipitation, the total carbonate concentration of the solution decreases, and these nanobubbles start to dissolve in the solution to reach equilibrium with the CO₂ partial pressure of the system. Therefore, higher hydroxide ion concentration will be needed to reach the target pH at higher pH points.

To summarize the examples shown herein, it was found that the precipitation trend of the REEs as a function of pH follows the tetrad classification in lanthanides when using NaOH. Tetrad classification is the consequence of the lanthanide contraction, which affects the coordination number of lanthanides and results in the variation of the solubility product of REEs. Using NaOH, a product of relatively high TREEs concentration (i.e., 4.6% TREEs) was achieved at pH 7 precipitate accounting for 70% TREEs recovery. When using CO₂, it was found that the REEs precipitation trend shifts towards lower pH values, which without wishing to be bound by any theory can be attributed to the lower Gibbs free energy of formation for REE-carbonates compared to that of REE-hydroxides. As a result, more than 85% cumulative TREEs recovery was obtained at pH 7 when using CO₂/NaOH. Additionally, more than 95% Al was recovered at pH 5, which facilitated a window for separation of Al from REE through staged precipitation.

Despite more than 15% improvement in TREE recovery, the concentration of the products was relatively lower (i.e., 1.3% TREE). Without wishing to be bound by any theory, this was attributed to the fact that the carbonate formations have a considerably higher molecular weight than the same metal-hydroxide formations. As shown in the present examples, 90% of Al and 15% of REEs (rich in Sc) can precipitate at the first step at pH 5. Then at the second step of the process at pH 7, another 70% of REEs can be recovered. In this process, the precipitation of most of the Fe content (i.e., 65%) is suppressed up to pH 7, eliminating its adverse effect on the downstream REE purification processes. This process enhances the sustainability of the AMD treatment process and can also be applied for the recovery of CEs from other low-concentration pregnant leach solutions.

### Example 5

To understand the value of REE sources to the market, the outlook coefficient (Cₒᵤₜₗₒₒₖ) evaluating the REE sources based upon the ratio of their content of critical REEs (Nd, Eu, Tb, Dy, Er, and Y) to the non-critical and excessive ones was introduced by Seredin and Dai (V. V. Seredin and S. Dai, “Coal deposits as potential alternative sources for lanthanides and yttrium,” International Journal of Coal Geology, vol. 94, p. 67-93, 2012) ((Eq. 9).

$$\begin{matrix}{C}_{o u t l o o k} = \frac{C r i t i c a l R E E}{E x c e s s i v e R E E} = \\ \frac{\left(N d + E u + T b + D y + E r + Y\right) / \sum R E E}{\left(C e + H o + T m + Y b + L u\right) / \sum R E E}\end{matrix} \qquad \text{(9)}$$

The higher the Cₒᵤₜₗₒₒₖ value, the more promising the REE source regarding potential industrial values. From the elemental analysis, the Cₒᵤₜₗₒₒₖ was calculated for the collected AMD sample and was compared with those of known REE sources reported in the literature (Table 5). The comparison shows that the Cₒᵤₜₗₒₒₖ of the sample is higher than that of some conventional REE minerals, i.e., bastnaesite and xenotime. Considering the potential value (high Cₒᵤₜₗₒₒₖ) of AMD and the fact that the AMDs are required to be neutralized, recovery of REEs from AMD streams can be feasible by a low-cost and environmentally friendly recovery process through modest modification of the neutralization process.

TABLE 5

Outlook coefficient (Cₒᵤₜₗₒₒₖ) value for some conventional and secondary sources.

| | | |
|---|---|---|
| Location | Source | Cₒᵤₜₗₒₒₖ |
| Mountain Pass | Bastnaesite | 0.23^{a} |
| Bayan Obo | Bastnaesite | 0.38 ^{a} |
| Lehat | Monazite | 0.49 ^{a} |
| Longnan | Xenotime | 5.13 ^{a} |
| West Kentucky | Xenotime | 13.73 ^{a} |
| Pennsylvania | Natural Coal-Based Leachate | 3.85 ^{b} |
| Lehat | AMD | 2.77 ^{c} |

^{a}Calculated based on the data from C. Zhanheng, “Global rare earth resources and scenarios of future rare earth industry,” Journal of Rare Earths, vol. 29, no. 1, p. 1-6, 2011
^{b}Data from “Rare earth elements recovery using staged precipitation from a leachate generated from coarse coal refuse,” International Journal of Coal Geology, vol. 195, p. 189-199, 2018.
^{c}Found in this research

Staged precipitation experiments were conducted using various chemicals, viz., NaOH, Na₂CO₃, Na₂HPO₄, NH₄OH, Na₂SO₄. For each set of experiments, a 20 L sample was first filtered to remove algae and coarse particles. All chemicals used in this example were of ACS grade. For staged precipitation, the pH of the solution was raised in subsequent steps to the target pH values (i.e., 4.5, 5, 6, 7, 8, and 9) using the chemicals of interest.

It was found that Na₂HPO₄ and Na₂SO₄ did not affect the solution pH. For these two chemicals, pH was raised using NaOH after adding a constant chemical dosage at each step. The concentration for these chemicals was chosen so that the ionic strength of the solution remained in the same order of magnitude as other chemicals while ensuring enough ligands concentration in the solution for the metal ions to form complexes, if thermodynamically possible. Table 6 shows the list of chemicals and their corresponding amounts used in each step of the experiments.

Once the pH of the solution was set to a target value, the solution was stirred for 24 hours to provide enough aging time for the precipitation and growth of the metal salts. The solution was then filtered through a 0.45 µm hydrophilic polyvinylidene fluoride (PVDF) filter (Durapore® membrane - Millipore-Sigma) in a high-pressure (700 kPa) filtration set-up to collect the precipitates from the system.

TABLE 6

Chemical usage in each stage of experiments

| # | Chemical | Amount Used (mg/l) | | | | | |
|---|---|---|---|---|---|---|---|
| | | pH 4.5 | pH 5.0 | pH 6.0 | pH 7.0 | pH 8.0 | pH 9.0 |
| 1 | NaOH | 32.0 | 86.0 | 12.6 | 4.8 | 7.2 | 23.0 |
| 2 | Na₂CO₃ | 34.5 | 135.1 | 18.6 | 4.2 | 7.4 | 34.5 |
| 3 | Na₂HPO₄ | 142 | 23.1 | 16.0 | 142.0 | 142.0 | 142.0 |
| | NaOH | 64.0 | 0.0 | 0.0 | 0.0 | 64.0 | 128.0 |
| 4 | NH₄OH | 90.8 | 77.8 | 20.7 | 5.2 | 13.0 | 129.7 |
| 5 | Na₂SO₄ | 116.2 | 116.2 | 116.2 | 116.2 | 116.2 | 116.2 |
| | NaOH | 53.2 | 68.0 | 4.0 | 4.8 | 17.6 | 164.0 |

The filter cake was then collected and dried in a vacuum (70 kPa) oven at 70° C. for 48 h, weighed, and stored sealed for further analyses. The solution was then subjected to the same procedure for the next target pH values. The experimental unit similar to the previous examples and as shown in FIG. 1A was used. The concentration of major anions in AMD and the precipitates at each stage was measured similarly to the examples shown above.

Elemental concentrations were used to calculate the elemental recovery values at various stages of the process using a modified equation 6′.

$$R e c o v e r y \left(\%\right) = 100 \times \frac{{C}_{p} \times {M}_{p}}{{C}_{A M D} \times {V}_{A M D}} \qquad \text{(6′)}$$

where Cₚ, Mₚ, C_{AMD}, and V_{AMD} are the concentration of the element in the precipitate (mg/g), the mass of precipitate (g), the concentration of the element in AMD (mg/L), and the total volume of AMD in the experiment (L), respectively.

Visual MINTEQ (V 3.1) was used to calculate the saturation index for the aqueous system with various ligands and REEs. Hydra/Medusa was also utilized to build speciation and Pourbaix diagrams for the systems of interest.

### Example 6

Ligands of interest (i.e., OH⁻, SO₄²⁻, NH₄⁺, CO₃²⁻, and PO₄³⁻) were used in staged precipitation of AMD to find the most effective reagent to be used for maximum recovery of critical elements from AMD while neutralizing to meet the discharge pH requirements. The ligands were provided to the system during the staged precipitation experiments using various chemicals listed in Table 6. NaOH is one of the common chemicals used in AMD active treatment. Therefore, a baseline staged precipitation experiment was conducted using NaOH, and the effect of other chemicals on TREEs precipitation was compared to that of the baseline experiment. The TREEs recovery and grade of the products of the baseline experiment are shown in FIG. 1A. It should be noted that the experiments conducted in this study are carefully monitored in terms of pH and aging time. Therefore, the results represent the highest values that a treatment facility could potentially achieve with properly controlled pH and well-designed settling ponds to satisfy the required aging time.

Na₂CO₃ and Na₂HPO₄ were used as sources of carbonate and phosphate ions, respectively, in the staged precipitation experiments to study the effect of such formations on the precipitation of REEs.

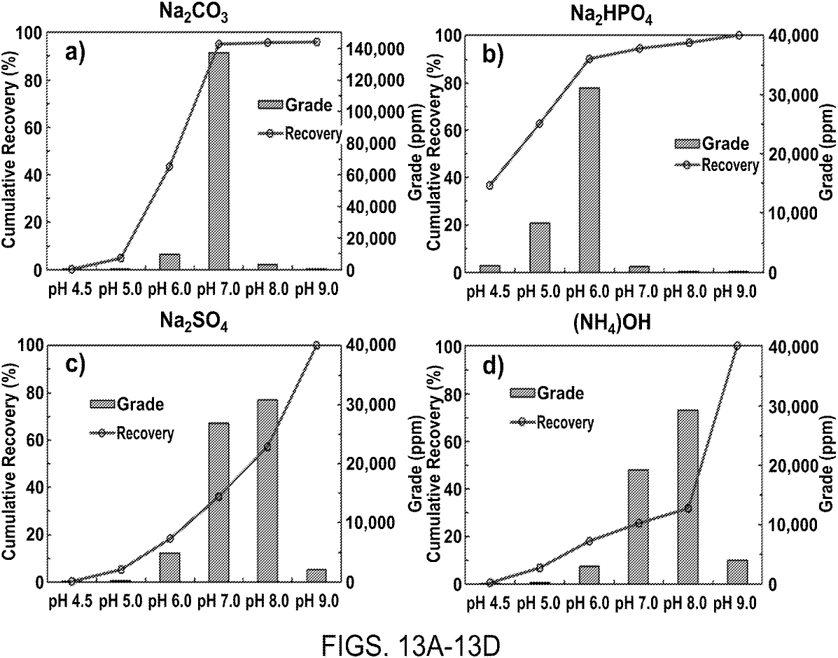

As shown in FIG. 13A and FIG. 13B, there is a distinct shift in the precipitation pattern of the REEs towards lower pH values when using these two chemicals compared with NaOH. It was found that using Na₂CO₃, over 95% of the TREEs can be recovered at pH 7. Even further, it was found that a high purity product with a TREEs grade of 13% was achieved when carbonate ions were used.

The distinct lower precipitation pH for REEs in the presence of carbonate ions coincided well with the results shown in the examples above, where the staged precipitation of AMD was done using CO₂ as a source of the carbonate.

Further, it was found that Na₂HPO₄ is utilized as a precipitation ligand, the REEs precipitation pH shifted to even lower pH values than those of Na₂CO₃, and up to 90% of TREEs was recovered at pH 6 (FIG. 13B). Additionally, REEs precipitation started at earlier pH stages compared with other chemicals.

Without wishing to be bound by any theory, it is hypothesized that the anion’s properties play a substantial role in aqueous chemistry. Molecular orbital energy gaps between the highest occupied molecular orbital and lowest unoccupied molecular orbital (HOMO-LUMO) are known to be one of the parameters governing the complexation and the ionic interactions. This energy gap is the basis for the hard-soft acid-base (HSAB) concept in the interaction between the anions and cations, known as Pearson acid-base concept. Based on the Pearson concept, the hard acid prefers to coordinate with a hard base, and soft acid with a soft base. Since trivalent lanthanides (Ln³⁺) are hard acids and they would prefer a hard base for coordination. Again, without wishing to be bound by any theory, the presence of an extra oxygen atom in the phosphate ion can increase its hardness compared to carbonate, while its hardness is relatively less than that of the hydroxide. It was found that there is a correlation between the precipitation in the presence of the disclosed ligands at a specific pH and the solubility constant of these REE complexes of these ligands.

It was found, however, that the REE-hydroxides precipitate at higher pH values despite their higher hardness and do not follow the mentioned above correlation. Without wishing to be bound by any theory, it was hypothesized that such behavior can be attributed to a possibility that the concentration of hydroxy groups in the solution at lower pH is considerably lower than that of other ligands. In other words, the adequate concentration of ligands for the phosphate and carbonate systems can be achieved at a relatively lower pH, while it may not be attainable in the case of hydroxide.

As further shown in FIG. 13C and FIG. 13D, Na₂SO₄, and (NH₄)OH were used in precipitation experiments to investigate the effect of ammonium/ammonia and sulfate anions on the precipitation pattern of the REEs. It has been previously reported that the solubility of the REE-double sulfates can vary for different REEs. While LREEs form more insoluble complexes, the rest of REEs are soluble to semi-soluble in the aqueous systems. Consequently, the precipitation pH decreases by increasing the atomic number of REEs. Although the expected major precipitation phase at basic pH is REE-hydroxide for all REEs, the pH range in which the REE-SO₄ complexes are dominant is different for each element. Again, without wishing to be bound by any theory, this behavior can affect the precipitation point of these elements as REE-SO₄ consumes available REE concentration in the system, preventing REE-hydroxide formation and precipitation (FIGS. 20A-20C).

As shown in FIG. 13C, when Na₂SO₄ was used in precipitation experiments, the TREEs recovery increased by increasing pH gradually. The TREEs recovery at pH 7 was found to be around 35%. It should be noted that the addition of Na₂SO₄ did not increase the pH by itself, and additional NaOH was utilized to increase the pH. It has been previously reported that the addition of relatively low concentrations of Na₂SO₄ can result in the crystallization of REE₂(SO₄)₃. Further addition of Na₂SO₄ can also result in double sulfate formations of REE-Na(SO₄)₂ with even lower solubility. REE-double sulfates can further convert to REE(OH)₃ by increasing the pH and addition of NaOH (eq. 10)

$$\begin{matrix}R E E ⋅ N a {\left(S {O}_{4}\right)}_{2} ⋅ x {H}_{2} O + N a O H ↔ R E E {\left(O H\right)}_{3} + 2 N {a}_{2} S {O}_{4} + \\ x {H}_{2} O\end{matrix} \qquad \text{(10)}$$

An additional precipitation ligand used in this example was ammonia. Ammonia is commonly used in AMD treatment facilities. It was found that in the presence of ammonium in the solution, the precipitation of REEs is suppressed to a great extent, where only 25% of TREEs precipitated at pH values up to 7 (as shown in FIG. 13D). However, as the solubility constant (pK) of the ammonium is 9.5, ammonium (NH₄⁺) starts to convert to ammonia (NH₃) after pH 8, where the REEs precipitation increases dramatically and reaches to 100% at pH 9.

When the solution pH is less than 9, the NH₃ ions tend to coordinate with H⁺ and form NH₄⁺. However, the hardness of hydron (H⁺) is much greater than that of lanthanides, and coordination of Ln-NH₃ is more likely. Consequently, and without wishing to be bound by any theory, it is assumed that the lanthanide ions in the solution are all occupied with ammonia, which can prevent their hydroxylation and further polymerization and precipitation. Once the pH increased above 8, the NH₃ concentration increases, and it becomes the dominant species to form NH₃+H₂O, releasing the coordinating lanthanide ions, which results in immediate precipitation of REEs at pH 9.

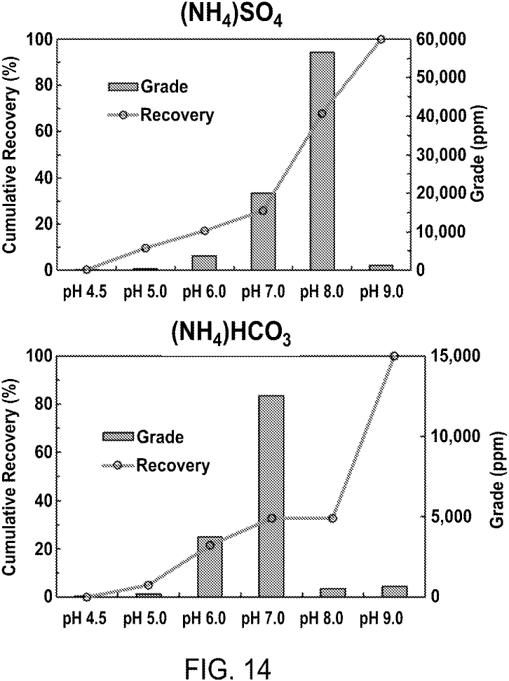

The increase in solubility of REE formations in the presence of ammonia or possible suppression of their precipitation was further evaluated using two other chemicals, namely (NH₄)₂SO₄ and (NH₄)HCO₃. The REEs precipitation patterns for these two chemicals are shown in FIG. 14. Comparison of these patterns with those of Na₂SO₄ and Na₂CO₃ (shown in FIG. 13A and FIG. 13C) indicates that the presence of ammonium seems to significantly reduce the TREEs precipitation.

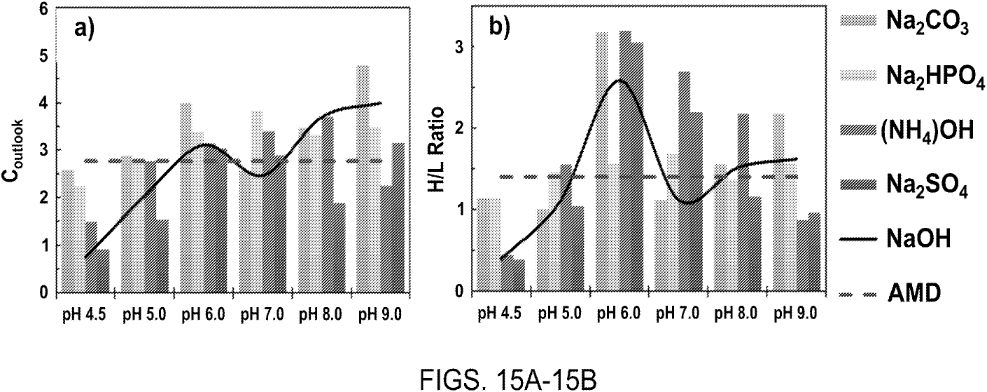

The outlook coefficient and H/L ratio at various precipitation stages for each chemical were studied as the indicators for the value of the products, and their correlations are shown in FIG. 15. The H/L ratio and Cₒᵤₜₗₒₒₖ of the sampled AMD were calculated as 1.4 and 2.77, respectively, as shown in FIG. 15 (dash lines).

It was found that the Cₒᵤₜₗₒₒₖ increases with increasing of the precipitation pH for all chemicals. The Cₒᵤₜₗₒₒₖ of the precipitates when NaOH was used (solid line) (FIG. 15A) shows that the excessive REEs were precipitated at pH 4.5 and 5, as the coefficient is lower than that of the feed material. Comparing with the trend of Cₒᵤₜₗₒₒₖ of precipitates when NaOH was used, it was observed that the carbonate ion is more effective in increasing the Cₒᵤₜₗₒₒₖ of the precipitates at lower pH. This trend was also followed by phosphate at lower pH values. Carbonate and phosphate ions are also demonstrating a similar pattern for the H/L ratio of the products at pH 4.5. When using NaOH, the LREEs tend to precipitate at lower pH (e.g., 4.5 and 5), while the HREEs precipitate heavily at pH 6 and 7 (FIG. 15B).

It was found, however, that using carbonates to precipitate REEs can increase the precipitation of HREEs at lower pH. Although the phosphate resulted in a significantly higher recovery of TREE (FIG. 13B), the H/L ratio of the products is around the same as the feed, which can indicate that the phosphate ions may not provide a specific selectivity towards any group of REEs in complexation and precipitation.

### Example 7

As was found in the examples described above, both carbonate and phosphate are very effective ligands for the recovery of REEs from AMDs. In this example, the saturation index for the selected REEs with these ligands was calculated to further study the effects of these ligands in the precipitation of REEs.

The solution chemistry study was conducted based on the solution equilibrium calculations using the Visual MINTEQ (v. 3.1). The saturation index (SI), as defined in eq. 11, was used to predict the possible precipitation pH for REE-complexes.

$$S I = log \frac{Q}{{K}_{s p}} \qquad \text{(11)}$$

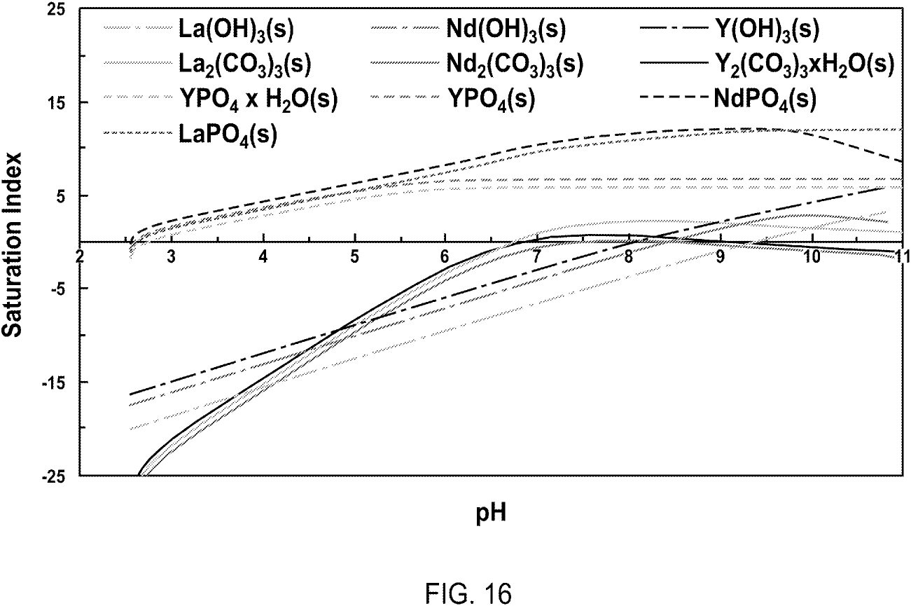

Here, Kₛₚ represents the solubility product, and Q is the reaction quotient. In aspects where SI is greater than 0 (SI>0), the solution is oversaturated (Q > Kₛₚ), and precipitation is likely, while further dissolution is expected when SI < 0 (Q < Kₛₚ). Three REEs, namely Y, La, and Nd, were used in SI calculations using Visual MINTEQ. The elemental concentrations of the systems were the same as those in the actual AMD sample. SI values for various formations of the aforementioned REEs are shown in FIG. 16. It was found that when NaOH was used in precipitation, the SI for the REE-hydroxides in the system is positive at a pH of around 8-9. However, when carbonate ions were used in calculations, the precipitation pH for the REEs decreased to pH 6.5-7.5. Furthermore, based on the SI values, it was assumed that the REE-phosphate will precipitate at a significantly lower pH. These findings are in good agreement with experimental results reported in FIG. 13.

Saturation data for the REEs supported the experimental findings, which revealed that more than 90% of TREEs recovery could be achieved during AMD treatment using Na₂CO₃ and Na₂HPO₄ chemicals at circumneutral pH, compared to 70% TREEs recovery using NaOH. However, the environmental concerns of phosphate release to aqueous streams, along with relatively high chemical consumption and cost, need to be also considered when choosing phosphates. On the other hand, Na₂CO₃ offers lower costs and is environmentally benign and thus could offer attractive possibilities for the recovery of REEs from AMD.

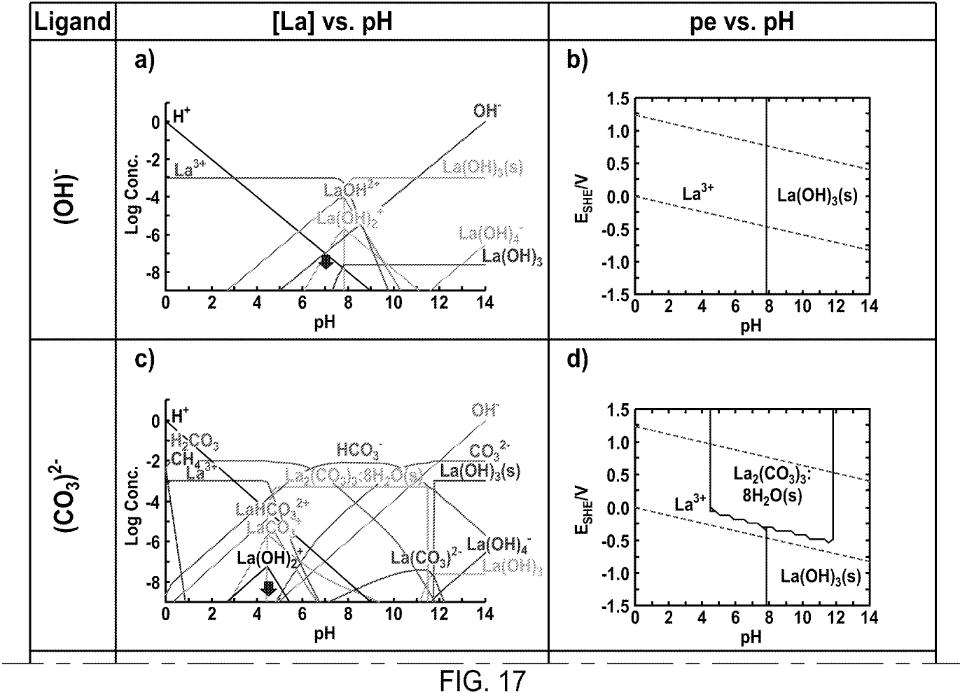

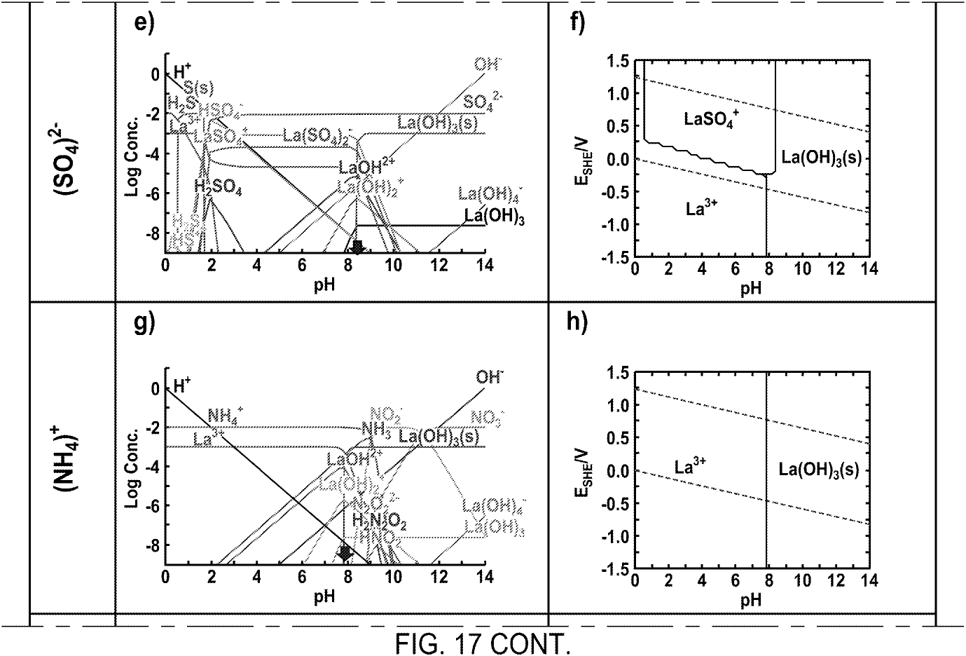

Speciation and Pourbaix diagrams of La in the presence of various ligands were calculated using Hydra/Medusa software (FIG. 17). The concentration of La and ligand in each system was 1 mM and 10 mM, respectively. Blue arrows in speciation diagrams (FIG. 17 (a - i)) indicate the pH at which the first solid formation occurs. Both experimental findings on REE precipitation at lower pH values using Na₂CO₃ and Na₂HPO₄ (FIG. 13), and calculated SI data (FIG. 16) were found to be in good agreement with the speciation diagrams.

It was found that La(OH)₃ precipitation can occur at pH above 8 (FIG. 17(a) ), while hydrated La(CO₃)₃ can be formed at around pH 4.5 in the presence of carbonate in the system (FIG. 17(c)). Without wishing to be bound by any theory, the LaPO₄ precipitate can be formed even at a strongly acidic pH of 1 (FIG. 17(i)) due to the very low solubility constant of Ln-phosphate salts. Again, without wishing to be bound by any theory, based on the findings of this example, it was suggested that the REE-phosphate salts can be precipitated from strong leachate solutions (e.g., pregnant leaching solutions) while other elements are soluble in the aqueous phase.

Experimental data obtained in this example showed that the presence of sulfate ions in the system shifts the precipitation pH of the REEs to higher values (FIG. 13C) compared with that of NaOH (FIG. 1B). Speciation and Pourbaix diagrams of the La-sulfate system (FIGS. 17(e-f)) revealed that the dominant La species in this system up to pH 8.5 is indeed LaSO₄⁺, which prevents La(OH)₃ formation and precipitation at pH below 8.5.

As further shown in FIG. 17 (g-h), La precipitation point in the presence of ammonium can be the same as that in the La-OH system. However, in the experimental studies, the precipitation behavior of REEs was found to be different when ammonium ions are present in the system. As shown in FIG. 13D precipitation of REEs was suppressed to some extend up to pH 9, after which, increased substantially. Interestingly, although any La-ammonium formations were not suggested in the Pourbaix diagram (FIG. 17(h)), La—NO₃²⁺ was found to be the dominant complex at pH 5 to 8.5, after which, La(OH)₃ formation can be foreseen. This speciation confirms the reason for the suppression of REEs precipitation up to pH 9, when (NH₄)OH was used (FIG. 13D).

### Example 8

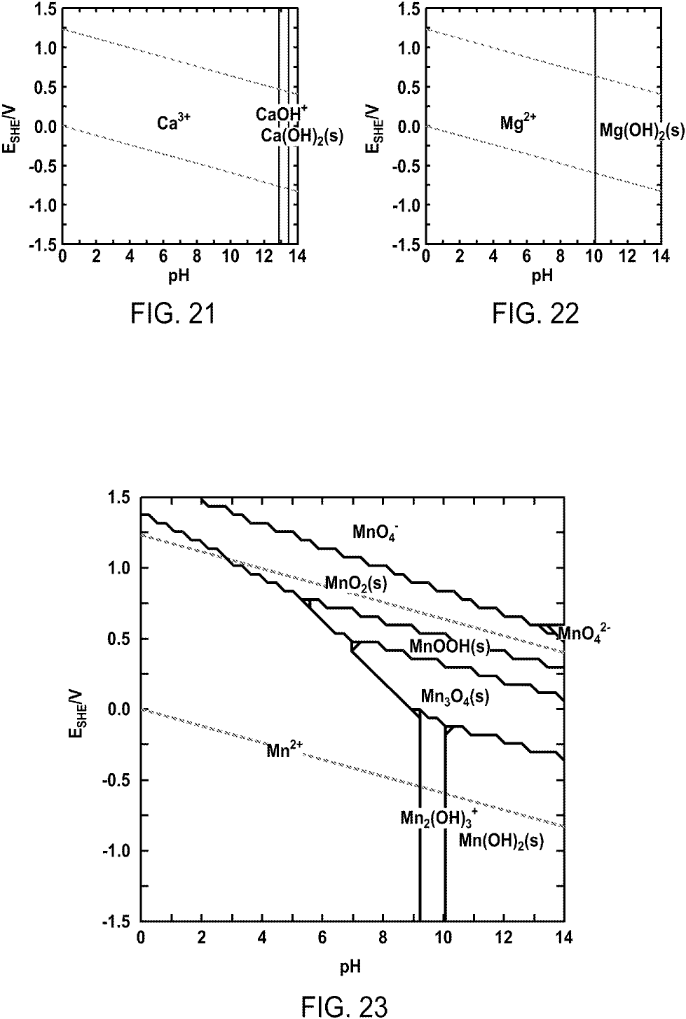

In this example, the precipitation and coprecipitation of additional elements were studied. It is understood that the concentration of these additional elements is considerably higher than that of REEs, and therefore coprecipitation of these elements can significantly decrease the TREE grade in the precipitates. It is noteworthy that, among the listed major elements in Table 1, Ca, Mg, Mn tend to precipitate at relatively higher pH, as have been discussed extensively in the literature and shown in Pourbaix diagrams (FIGS. 21-23).

It was found that the precipitation of Mn using NaOH starts at pH 9, where only 18% of total Mn can be recovered. On the other hand, when Na₂HPO₄ was used, the Mn precipitation shifted to pH 8, where 80% of total Mn was precipitated. Moreover, both Ca, and Mg were not recovered from the AMD with any of the ligands, as these elements precipitate at pH values higher than 10, depending on their concentration in the system. Such behavior of Ca and Mg provides an opportunity for a high-grade yield in precipitations. AI and Fe were the two elements that showed considerably different precipitation behavior depending on the ligand type. FIG. 18 shows the precipitation and cumulative recovery of AI and Fe at various pH stages in the presence of ligands of interest.

As shown in FIG. 18, when NaOH was used, only 65% of AI precipitated in the pH range of 4.5 to 8, and mainly at pH 5. Passivation by a film of hydrargillite (Al₂O₃·3H₃O) has been reported previously by Pourbaix between pH 4-9, which indicates that this formation could be stable at this pH range. It has been reported that due to the hardness of Al³⁺ ion compared to the REE³⁺ ions, the precipitation of AIPO₄ competes with the precipitation of REEPO₄. Without wishing to be bound by any theory, this possible precipitation was assumed to be the reason for lower TREE recovery (and grade) at the first stage (pH 4.5) despite the reported higher REE-phosphate precipitation at such low pH values.

It was found that over 90% of AI is precipitated at pH 4.5 when phosphate was used (FIG. 18), which may consume the phosphate ions and prevent further REEs precipitation. Interestingly, all other studied chemicals were found to have similar trends for the AI recovery, where 80-85% of AI was recovered at pH 5, and over 90% recovery was achieved starting at pH 6.

### Example 9

For REE recovery from AMD at target pH values for the treatment process, Na₂CO₃ was found to be the most effective chemical considering precipitation performance, chemical consumption and cost, and environmental concerns. The different precipitation patterns of REEs (FIG. 13A and FIG. 13B) and the major elements (FIG. 18) when using Na₂CO₃ also provided a window for selective precipitation of these elements at various treatment stages.

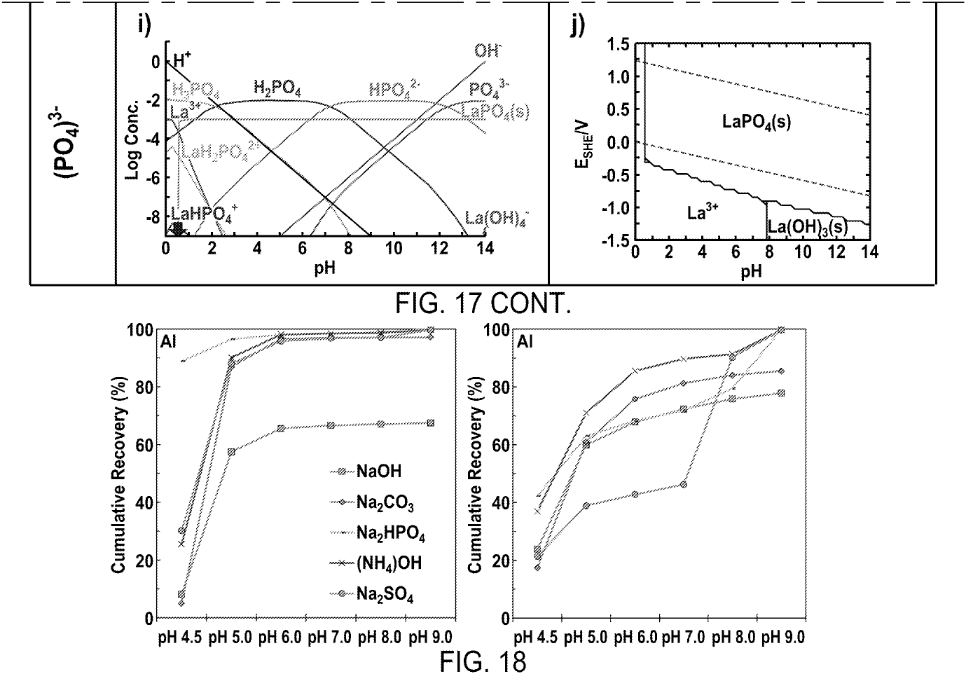

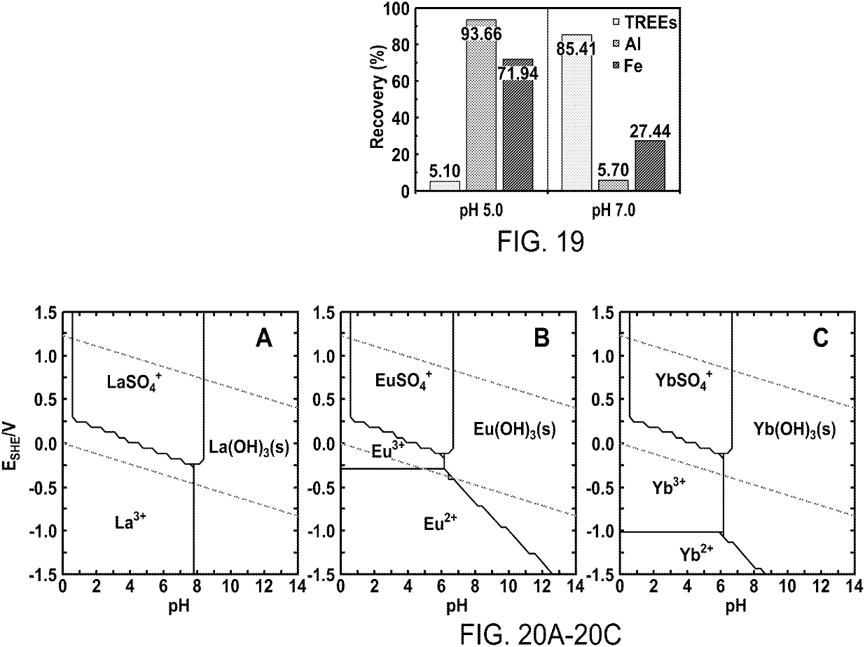

Accordingly, practical modifications to the current AMD treatment process were formulated to recover these elements through a sequential two-step neutralization process at pH 5 and 7 to precipitate AI and REEs, respectively, using Na₂CO₃. FIG. 19 shows the precipitation/recovery of TREEs and major elements in the proposed two-step AMD treatment process. It was found that the Al³⁺ and REE³⁺ ions can be easily separated from each other at these two steps. Such segregation is of significant advantage for downstream purification processes where the separation of AI and REEs with the same oxidation state could be tedious. As the results show, over 93% of AI can be precipitated at pH 5 using Na₂CO₃ while only 5% of TREEs precipitates at that pH. In the following step, at pH 7, when the AMD is neutralized, the remaining AI that precipitates is only 5.7%. At this stage, over 85% of TREEs can be precipitated and recovered. It is evident that the majority of Fe precipitates at lower pH, which results in a relatively cleaner TREE product at a pH 7. The concentration of AI in precipitates of the first stage was 30% (by weight), and the TREE concentration at the second step was 16,000 ppm.

The lower concentration of TREEs in the proposed process compared to that of the staged precipitation experiment (i.e., 16,000 ppm compared to 14%, respectively) was due to the fact that the stages in the proposed two-step process were combined. Such a merger was considered for this process from the practical point of view for the modification of the current AMD treatment practices. However, the TREEs concentration in the product of the proposed process is still significantly higher than that of precipitates (i.e., sludge) of current AMD treatment processes. The TREE concentration in the corresponding sludge sample collected from the same AMD treatment site was found to be 1043 ppm (the elemental content of the AMD sludge sample is presented in Table 7). This clearly shows that the proposed two-stage process increases the recovery of TREE from 70% in the conventional AMD treatment process to over 85% and yields a product of 15 times higher TREE than the sludge.

TABLE 7

Elemental content of the sludge material collected from the neutralization process of the sampled AMD

| HREE (ppmv) | Y | Eu | Gd | Tb | Dy | Ho | Er | Tm | Yb | Lu |
|---|---|---|---|---|---|---|---|---|---|---|
| | 350.98 | 12.88 | 75.40 | 11.62 | 67.0 | 12.41 | 33.61 | 4.08 | 24.16 | 3.51 |
| LREE (ppmv) | Sc | La | Ce | Pr | Nd | Sm | HREE | LREE | TREE | H/L |
| | 22.59 | 50.83 | 165.57 | 25.64 | 136.83 | 46.12 | 595 | 447 | 1043 | 1.33 |
| Major Cation s (ppmᵥ) | AI | Fe | Ca | Mg | Mn | Si | Co | Ni | Cu | Zn |
| | 100019 | 27778 | 14175 | 114350 | 56841 | n/d | 853 | 978 | 21 | 1754 |

The claims are not intended to include, and should not be interpreted to include, means-plus- or step-plus-function limitations, unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

### Aspects

Aspect 1: A method comprising n stages, wherein the method comprises: a first of the n stages comprising: a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, phosphate salt, dihydrogen phosphate salt, hydrogen phosphate salt, or any combinations thereof of the one or more rare earth elements for a first predetermined period of time; b) adjusting the first predetermined pH of the first solution to reach a second predetermined pH, wherein the second predetermined pH is higher than the first predetermined pH; c) aging the first solution for a second predetermined period of time at conditions effective to form a first liquid fraction and a first solid fraction, wherein the first solid fraction comprises at least one of the one or more rare earth element salts; d) separating the first solid fraction from the first liquid fraction; and repeating steps a)-d) for n times, wherein: a first solution in step a) of each subsequent stage is substantially similar to a first liquid fraction formed in step d) of each preceding stage; wherein a first predetermined pH at step a) of each subsequent stage is higher than a first predetermined pH at step a) of each preceding stage; wherein a second predetermined pH in step b) of each subsequent stage is higher than the first predetermined pH at step a) of the same stage, and wherein n is at least 2 stages.

Aspect 2: The method of Aspect 1, wherein the reagent comprises a carbon dioxide gas, a carbonate salt, bicarbonate salt, phosphate salt, dihydrogen phosphate salt, hydrogen phosphate salt, or a combination thereof.

Aspect 3: The method of Aspect 2, wherein the one or more of the carbonate salt, bicarbonate salt, phosphate salt, dihydrogen phosphate salt, hydrogen phosphate salt are provided as a solution, as a solid, or as a combination thereof.

Aspect 4: The method of any one of Aspects 1-3, wherein the reagent is the carbon dioxide gas, the carbonate salt, the bicarbonate salt, or a combination thereof.

Aspect 5: The method of any one of Aspects 1-4, wherein the at least one of the one or more rare earth element salts in the first solid fraction of the first stage and a first solid fraction of each subsequent stage comprises a second quantity of the one or more rare earth elements.

Aspect 6: The method of Aspect 5, further comprising measuring the second quantity of the one or more rare earth elements at the first stage and at each subsequent stage.

Aspect 7: The method of Aspect 6, wherein a total second quantity of the one or more rare earth elements comprises a sum of each of the second quantities measured at each of n^{th} stages, and wherein the total second quantity of the one or more rare earth elements comprises at least 70 % of the first quantity of the one or more rare earth elements present in the first solution in the first stage.

Aspect 8: The method of any one of Aspects 1-7, wherein the one or more rare earth elements present in the first solution at the first stage comprises at least one or more of light rare earth elements (LREEs), at least one or more of heavy rare earth elements (HREEs), or a combination thereof.

Aspect 9: The method of any one of Aspects 1-8, wherein the LREEs comprise one or more of Sc, La, Ce, Pr, Nd, or Sm.

Aspect 10: The method of any one of Aspects 1-9, wherein the HREEs comprise one or more of Y, Eu, Gd, Tb, Dy, Ho, Er, Tm, Yb, or Lu.

Aspect 11: The method of any one of Aspects 1-10, wherein the first solution in the first stage comprises an acid mine drainage, natural leachate, pregnant leaching solutions, or a combination thereof.

Aspect 12: The method of any one of Aspects 1-11, wherein the first solution in the first stage is filtered prior to step a) of the first stage to remove coarse impurities.

Aspect 13: The method of any one of Aspects 1-12, wherein the first predetermined pH in step a) of the first stage is from 0 to about 6.

Aspect 14: The method of any one of Aspects 1-13, wherein step b) of the first stage and each subsequent stage comprises adding a base.

Aspect 15: The method of Aspect 14, wherein the base comprises a solution, a gas, a solid, or any combinations thereof.

Aspect 16: The method of any one of Aspects 1-15, wherein the second predetermined pH in step b) of the first stage is at least 0.5 unit higher than the first predetermined pH in step a) of the first stage.

Aspect 17: The method of any one of Aspects 1-16, wherein the second predetermined pH in step b) of each subsequent stage of the n stages is at least 0.5 unit higher than the first predetermined pH in step a) of the same stage.

Aspect 18: The method of any one of Aspects 1-17, wherein the first predetermined time in step a) of the first stage and a first predetermined time in step a) of each subsequent stage is the same or different, and it ranges from greater than 0 to about 72 hours.

Aspect 19: The method of any one of Aspects 1-18, wherein the second predetermined time in step c) of the first stage and a second predetermined time in step c) of each subsequent stage is the same or different, and it ranges from greater than 0 to about 72 hours.

Aspect 20: The method of any one of Aspects 1-19, wherein the second predetermined pH of the n^{th} stage is from about 8 to about 14.

Aspect 21: The method of any one of Aspects 1-20, wherein the first solution in steps a)-c) in the first stage and the first solution in steps a)-c) in each subsequent stage are further stirred.

Aspect 22: The method of any one of Aspects 5-21, wherein at least about 70 % of the total second quantity of the one or more rare earth elements is collected at a stage having a second predetermined pH from about 5 to about 8.

Aspect 23: The method of any one of Aspects 5-22, wherein at least about 85 % of the total second quantity of the one or more rare earth elements is collected at a stage having a second predetermined pH of less than 8.

Aspect 24: The method of any one of Aspects 5-23, wherein up to about 90 % of the total second quantity of the one or more rare earth elements is collected at a stage having a second predetermined pH of less than 8.

Aspect 25: The method of any one of Aspects 5-24 wherein at least 70 % of the total second quantity of the one or more rare earth elements is collected at a stage having a second predetermined pH at least one unit lower when compared to substantially identical reference method that does not comprise step a) of treating the first solution with the reagent.

Aspect 26: The method of any one of Aspects 1-25, wherein the first solid fraction in the first stage and the first solid fraction in each subsequent stage further comprises one or more of iron, aluminum, calcium, magnesium, or manganese.

Aspect 27: The method of any one of Aspects 1-26, wherein the method is an REE recovery method.

Aspect 28: The method of any one of Aspects 1-27, wherein the method is a carbon dioxide sequestration method.

Aspect 29: A method comprising: a) treating a solution having a first predetermined pH and comprising a first quantity of one or more rare earth elements (REEs) and a second quantity of one or more of iron, aluminum, calcium, magnesium, or manganese with a reagent under conditions effective to form: i) a salt comprising one or more of a carbonate of one or more earth element, bicarbonate of one or more rare earth element, hydroxycarbonate of one or more rare earth element or a combination thereof, and a precipitate of one or more of iron, aluminum, calcium, magnesium, or manganese, or a combination thereof, for a first predetermined period of time to form a first liquid fraction and a first solid fraction, wherein the first solid fraction comprises the precipitate of one or more of iron, aluminum, calcium, magnesium, or manganese; b) adjusting the first predetermine pH of the solution to reach a second predetermined pH, wherein the second pH is higher than the first predetermined pH; c) aging the first solution for a second predetermined period of time at conditions effective to form a second liquid fraction and a second solid fraction, wherein the second solid fraction comprises at least one of the carbonate of one or more rare earth element, bicarbonate of one or more rare earth element, hydroxycarbonate of one or more rare earth element, or a combination thereof; and ; d) collecting the first solid fraction and the second solid fraction.

Aspect 30: The method of Aspect 29, wherein the precipitate of one or more of aluminum, iron, calcium, magnesium, or manganese comprises a hydroxide, carbonate, bicarbonate, or a combination of thereof of the one or more of aluminum, iron, calcium, magnesium, or manganese.

Aspect 31: The method of Aspect 29 or 30, wherein the first solid fraction is collected before step b).

Aspect 32: The method of any one of Aspects 29-31, wherein the reagent is the carbon dioxide gas, the carbonate salt, the bicarbonate salt, or a combination thereof.

Aspect 33: The method of any one of Aspects 29-32 wherein the carbonate salt and/or the bicarbonate salt are provided as a solution, as a solid, or as a combination thereof.

Aspect 34: The method of any one of Aspects 29-33, wherein the first pH is between 3.5 to 5.5.

Aspect 35: The method of any one of Aspects 29-34, wherein the second pH is between 6 and 7.5

Aspect 36: The method of any one of Aspects 29-35, wherein the first solid fraction comprises the precipitate of aluminum.

Aspect 37: The method of Aspect 36, wherein the first solid fraction comprises at least 80 % of all aluminum present in the solution.

Aspect 38: The method of any one of Aspects 29-37, wherein the second solid fraction comprises at least 75 % of the first quantity of the one or more rare earth elements.

Aspect 39: The method of any one of Aspects 29-38, wherein the solution comprises an acid mine drainage, natural leachate, pregnant leaching solutions, or a combination thereof, having an initial pH.

Aspect 40: The method of Aspect 39, wherein the initial pH is from 0 to about 6.

Aspect 41: A method comprising n stages, wherein the method comprises: a first of the n stages comprising: a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, or any combinations thereof of the one or more rare earth elements for a first predetermined period of time; b) adjusting the first predetermined pH of the first solution to reach a second predetermined pH, wherein the second predetermined pH is higher than the first predetermined pH; c) aging the first solution for a second predetermined period of time at conditions effective to form a first liquid fraction and a first solid fraction, wherein the first solid fraction comprises at least one of the one or more rare earth element salts; d) separating the first solid fraction from the first liquid fraction; and repeating steps a)-d) for n times, wherein: a first solution in step a) of each subsequent stage is substantially similar to a first liquid fraction formed in step d) of each preceding stage; wherein a first predetermined pH at step a) of each subsequent stage is higher than a first predetermined pH at step a) of each preceding stage; and wherein a second predetermined pH in step b) of each subsequent stage is higher than the first predetermined pH at step a) of the same stage, and wherein n is at least 2 stages.

Aspect 42: The method of Aspect 41, wherein the reagent comprises a carbon dioxide gas, carbonate salt, bicarbonate, or a combination thereof.

Aspect 43: The method of Aspect 42, wherein the carbonate salt and/or the bicarbonate salt are provided as a solution, as a solid, or as a combination thereof.

Aspect 44: The method of any one of Aspects 41-43, wherein the at least one of the one or more rare earth element salts in the first solid fraction of the first stage and a first solid fraction of each subsequent stage comprises a second quantity of the one or more rare earth elements.

Aspect 45: The method of Aspect 44, further comprising measuring the second quantity of the one or more rare earth elements at the first stage and at each subsequent stage.

Aspect 46: The method of Aspect 45, wherein a total second quantity of the one or more rare earth elements comprises a sum of each of the second quantities measured at each of n^{th} stages, and wherein the total second quantity of the one or more rare earth elements comprises at least 70 % of the first quantity of the one or more rare earth elements present in the first solution in the first stage.

Aspect 47: The method of any one of Aspects 41-46, wherein the one or more rare earth elements present in the first solution at the first stage comprises at least one or more of light rare earth elements (LREEs), at least one or more of heavy rare earth elements (HREEs), or a combination thereof.

Aspect 48: The method of any one of Aspects 41-47, wherein the LREEs comprise one or more of Sc, La, Ce, Pr, Nd, or Sm.

Aspect 49: The method of any one of Aspects 41-48, wherein the HREEs comprise one or more of Y, Eu, Gd, Tb, Dy, Ho, Er, Tm, Yb, or Lu.

Aspect 50: The method of any one of Aspects 41-49, wherein the first solution in the first stage comprises an acid mine drainage, natural leachate, pregnant leaching solutions, or a combination thereof.

Aspect 51: The method of any one of Aspects 41-50, wherein the first solution in the first stage is filtered prior to step a) of the first stage to remove coarse impurities.

Aspect 52: The method of any one of Aspects 41-51, wherein the first predetermined pH in step a) of the first stage is from 0 to about 6.

Aspect 53: The method of any one of Aspects 41-52, wherein step b) of the first stage and each subsequent stage comprises adding a base.

Aspect 54: The method of Aspect 53, wherein the base comprises a solution, a gas, a solid, or any combinations thereof.

Aspect 55: The method of any one of Aspects 41-54, wherein the second predetermined pH in step b) of the first stage is at least 0.5 unit higher than the first predetermined pH in step a) of the first stage.

Aspect 56: The method of any one of Aspects 41-55, wherein the second predetermined pH in step b) of each subsequent stage of the n stages is at least 0.5 unit higher than the first predetermined pH in step a) of the same stage.

Aspect 57: The method of any one of Aspects 41-56, wherein the first predetermined time in step a) of the first stage and a first predetermined time in step a) of each subsequent stage is the same or different, and it ranges from greater than 0 to about 72 hours.

Aspect 58: The method of any one of Aspects 41-57, wherein the second predetermined time in step c) of the first stage and a second predetermined time in step c) of each subsequent stage is the same or different, and it ranges from greater than 0 to about 72 hours.

Aspect 59: The method of any one of Aspects 41-58, wherein the second predetermined pH of the n^{th} stage is from about 8 to about 14.

Aspect 60: The method of any one of Aspects 41-59, wherein the first solution in steps a)-c) in the first stage and the first solution in steps a)-c) in each subsequent stage are further stirred.

Aspect 61: The method of any one of Aspects 44-60, wherein at least 70 % of the total second quantity of the one or more rare earth elements is collected at a stage having a second predetermined pH from about 5 to about 8.

Aspect 62: The method of any one of Aspects 44-61 wherein at least 70 % of the total second quantity of the one or more rare earth elements is collected at a stage having a second predetermined pH at least 0.5 unit lower when compared to substantially identical reference method that does not comprise step a) of treating the first solution with the reagent.

Aspect 63: The method of any one of Aspects 41-62, wherein the first solid fraction in the first stage and the first solid fraction in each subsequent stage further comprises one or more of iron, aluminum, calcium, magnesium, or manganese.

Aspect 64: The method of any one of Aspects 41-63, wherein the method is an REE recovery method.

Aspect 65: The method of any one of Aspects 41-64, wherein the method is a carbon dioxide sequestration method.

### REFERENCES

V. Balaram, “Rare earth elements: A review of applications, occurrence, exploration, analysis, recycling, and environmental impact,” Geoscience Frontiers, vol. 10, pp. 1285-1303, 2019.

D. Merten and G. Büchel, “Determination of Rare Earth Elements in Acid Mine Drainage by Inductively Coupled Plasma Mass Spectrometry,” Microchim. Acta, vol. 148, pp. 163-170, 2004.

A. Jordens, Y. P. Cheng and K. E. Waters, “A review of the beneficiation of rare earth element bearing minerals,” Minerals Engineering, vol. 41, pp. 97-114, 2013.

R. J. Weber and D. J. Reisman, Rare earth elements: A review of production, processing, recycling, and associated environmental issues, Office of Research and Development - US EPA, 2012.

K. Binnemas, P. T. Jones, B. Blanpain, T. V. Gerven, Y. Yang, A. Walton and M. Buchert, “Recycling of rare earths: a critical review,” Journal of Cleaner Production, vol. 51, pp. 1-22, 2013.

U.S. Geological Survey, Mineral commodity summaries 2019, U.S. Geological Survey, 2019, p. 200.

European Commission, “Study on the review of the list of critical raw materials -Critical Assessments,” Luxembourg, 2017.

European Commission, “Report on Critical Raw Materials and the Circular Economy,” Luxembourg, 2018.

Department of the Interior, Final List of Critical Minerals - Federal Register 83 FR 23295, Federal Register, 2018.

K. Binnemans, P. T. Jones, B. Blanpain, T. V. Gerven and Y. Pontikes, “Towards zero-waste valorisation of rare-earth-containing industrial process residues: a critical review,” Journal of Cleaner Production, vol. 99, pp. 17-38, 2015.

M. K. Jha, A. Kumari, R. Panda, J. R. Kumar, K. Yoo and J. Y. Lee, “Review on hydrometallurgical recovery of rare earth metals,” Hydrometallurgy, vol. 165, pp. 2-26, 2016.

C. R. Borra, B. Blanplain, Y. Pontikes, K. Binnemans and T. V. Gerven, “Recovery of Rare Earths and Other Valuable Metals From Bauxite Residue (Red Mud): A Review,” J. Sustain. Metall., vol. 2, pp. 365-386, 2016.

W. Zhang, M. Rezaee, A. Bhagavatula, Y. Li, J. Groppo and R. Honaker, “A Review of the Occurrence and Promising Recovery Methods of Rare Earth Elements from Coal and Coal By-Products,” International Journal of Coal Preparation and Utilization, vol. 35, no. 6, pp. 295-330, 2015.

W. Zhang and R. Q. Honaker, “Rare earth elements recovery using staged precipitation from a leachate generated from coarse coal refuse,” International Journal of Coal Geology, vol. 195, pp. 189-199, 2018.

C. Ayora, F. Macias, E. Torres, A. Lozano, S. Carrero, J.-M. Nieto, R. Pérez-López, A. Fernández-Martínez and H. Castillo-Michel, “Recovery of Rare Earth Elements and Yttrium from Passive-Remediation Systems of Acid Mine Drainage,” Environmental Science and Technology, vol. 50, pp. 8255-8262, 2016.

S. Kashiwakura, Y. Kumagai, H. Kubo and K. Wagatsuma, “Dissolution of Rare Earth Elements from Coal Fly Ash Particles in a Dilute H2SO4 Solvent,” Open Journal of Physical Chemistry, vol. 3, pp. 69-75, 2013.

P. L. Rozelle, A. B. Khadilkar, N. Pulati, N. Soundarrajan, M. S. Klima, M. M. Mosser, C. E. Miller and S. V. Pisupati, “A Study on Removal of Rare Earth Elements from U.S. Coal Byproducts by Ion Exchange,” Metallurgical and Materials Transactions E, vol. 3, no. 1, pp. 6-17, 2016.

R. B. Finkelman, “Trace and Minor Elements in Coal,” in Organic Geochemistry: Principles and Applications, vol. 2, M. H. Engel and S. A. Macko, Eds., New York, Springer Science+Business Media, LLC, 1977, pp. 593-607.

X. Tang and W. Huang, “Trace elements in coal and significance of the research,” Coal Geology of China, vol. 14, pp. 1-4, 2002.

D. Birk and J. C. White, “Rare earth elements in bituminous coals and underclays of the Sydney Basin, Nova Scotia: Element sites, distribution, mineralogy,” International Journal of Coal Geology, vol. 19, pp. 219-251, 1991.

W. Zhang, R. Honaker and J. Groppo, “Concentration of rare earth minerals from coal by froth flotation,” Minerals & Metallurgical Processing, vol. 34, no. 3, pp. 132-137, 2017.

D. J. Swaine, Trace Elements in Coal, North Ryde: Butterworth-Heinemann, 1990.

C. Palmer, P. Lyons, Z. Brown and J. Mee, “The use of trace element concentrations in vitrinite concentrates and companion whole coals (hvA bituminous) to determine organic and inorganic associations,” GSA Special Paper, vol. 248, pp. 55-62, 1990.

D. B. Johnson and K. B. Hallberg, “Acid mine drainage remediation options: a review,” Science of the Total Environment, vol. 338, pp. 3-14, 2005.

A. RoyChowdhury, D. Sarkar and R. Datta, “Remediation of Acid Mine Drainage-Impacted Water,” Current Pollution Reports, vol. 1, no. 3, pp. 131-141, 2015.

A. Akcil and S. Koldas, “Acid Mine Drainage (AMD): causes, treatment and case studies,” Journal of Cleaner Production, vol. 14, pp. 1139-1145, 2006.

J. G. Skousen, P. F. Ziemkiewicz and L. M. McDonald, “Acid mine drainage formation, control and treatment: Approaches and strategies,” The Extractive Industries and Society, vol. 6, pp. 241-249, 2019.

M. Rezaee, V. N. Rajagopalan and R. Q. Honaker, “Conceptual modifications of coal preparation plants to minimize potential environmental issues associated with coal waste disposal,” Fuel, vol. 250, pp. 352-361, 2019.

C. R. Vass, A. Noble and P. F. Ziemkiewicz, “The Occurrence and Concentration of Rare Earth Elements in Acid Mine Drainage and Treatment By-products: Part 1-Initial Survey of the Northern Appalachian Coal Basin,” Mining, Metallurgy & Exploration, 2019.

M. Rezaee, F. Huggins and R. Q. Honaker, Environmental Consideration in Energy Production, Denver: Society for Mining, Metallurgy, and Exploration (SME), 2013.

M. Rezaee, R. C. Warner and R. Q. Honaker, “Development of an electrical conductivity screening test for mine waste assessments,” Chemosphere, vol. 160, pp. 13-21, 2016.

C. Agouridis, P. Angel, T. Taylor, C. Barton, R. Warner, X. Yu and C. Wood, “Water quality characteristics of discharge from reforested loose-dumped mine spoil in eastern Kentucky,” Journal of Environmental Quality, vol. 41, no. 2, pp. 454-468, 2012.

U. EPA., “A Field-Based Aquatic Life Benchmark for Conductivity in Central Appalachian Streams (EPA/600/R-10/023A),” U.S. Environmental Protection Agency, Washington, 2010.

J. Delgado, R. Pérez-López, L. Galván, J. M. Nieto and T. Boski, “Enrichment of rare earth elements as environmental tracers of contamination by acid mine drainage in salt marshes: A new perspective,” Marine Pollution Bulletin, vol. 64, no. 9, pp. 1799-1808, 2012.

R. L. Wolke, “Marie Curie’s Doctoral Thesis: Prelude to a Nobel Prize,” Journal of Chemical Education, vol. 65, no. 7, pp. 561-573, 1988.

F. P. Carvalho, “Marie Curie and the Discovery of Radium,” in The New Uranium Mining Boom, B. Merkel and M. Schipek, Eds., Berlin, Springer, pp. 3-13, 2011.

X. Wei, R. C. Viadero and K. M. Buzby, “Recovery of Iron and Aluminum from Acid Mine Drainage by Selective Precipitation,” Environmental Engineering Science, vol. 22, no. 6, pp. 745-755, 2005.

E. Kim and K. Osseo-Asare, “Aqueous stability of thorium and rare earth metals in monazite hydrometallurgy: Eh-pH diagrams for the systems Th-, Ce-, La-, Nd-(PO4)-(SO4)-H2O at 25° C.,” Hydrometallurgy, Vols. 113-114, pp. 67-78, 2012.

F. H. Firsching and S. N. Bruñe, “Solubility products of the trivalent rare-earth phosphates,” Journal of Chemical and Engineering Data, vol. 36, no. 1, pp. 93-95, 1991.

R. C. Stover, L. E. Sommers and D. J. Silviera, “Evaluation of Metals in Wastewater Sludge,” Water Pollution Control Federation, vol. 48, no. 9, pp. 2165-2175, 1976.

D. G. Brookins, Eh-pH Diagrams for Geochemistry, Berlin: Springer-Verlag, 1988.

A. Sanna, M. Uibu, G. Caramanna, R. Kuusik and M. M. Maroto-Valer, “A review of mineral carbonation technologies to sequester CO2,” Chem Soc Rev, vol. 43, pp. 8049-8080, 2014.

S. J. Schatzel and B. W. Stewart, “Rare earth element sources and modification in the Lower Kittanning coal bed, Pennsylvania: implications for the origin of coal mineral matter and rare earth element exposure in underground mines,” International Journal of Coal Geology, vol. 54, pp. 223-251, 2003.

Y. Xiao, X. Liu, Z. Feng, X. Huang, G. Huan, Y. Chen and W. Wu, “Role of minerals properties on leaching process of weathered crust elution-deposited rare earth ore,” Journal of Rare Earths, vol. 33, no. 5, pp. 545-552, 2015.

J. C. Hower, C. F. Eble, S. Dai and H. E. Belkin, “Distribution of rare earth elements in eastern Kentucky coals: Indicators of multiple modes of enrichment?,” International Journal of Coal Geology, Vols. 160-161, pp. 73-81, 2016.

V. V. Seredin, “Rare earth element-bearing coals from the Russian Far East deposits,” International Journal of Coal Geology, vol. 30, no. 1-2, pp. 101-129, 1996.

C. R. Vass, A. Noble and P. F. Ziemkiewicz, “The Occurrence and Concentration of Rare Earth Elements in Acid Mine Drainage and Treatment Byproducts. Part 2: Regional Survey of Northern and Central Appalachian Coal Basins,” Mining, Metallurgy & Exploration, vol. 36, no. 5, pp. 917-929, 2019.

V. Philippini, T. Vercouter, A. Chaussé and P. Vitorge, “Precipitation of ALn (CO3) 2, xH2O and Dy2 (CO3) 3, xH2O compounds from aqueous solutions for A+= Li+, Na+, K+, Cs+, NH4+ and Ln3+= La3+, Nd3+, Eu3+, Dy3+,” Journal of Solid State Chemistry, vol. 181, no. 9, pp. 2143-2154, 2008.

J. D. Rodriguez-Blanco, B. Vallina, J. A. Blanco and L. G. Benning, “The Role of REE3+ in the crystallization of lanthanides,” Mineralogical Magazine, vol. 78, no. 6, pp. 1373-1380, 2014.

G. B. Abaka-Wood, M. Zanin, J. Addai-Mensah and W. Skinner, “Recovery of rare earth elements minerals from iron oxide-silicate rich tailings - Part 1: Magnetic separation,” Minerals Engineering, vol. 136, pp. 50-61, 2019.

S. Wu, L. Wang, L. Zhao, P. Zhang, H. El-Shall, B. Moudgil, X. Huang and L. Zhang, “Recovery of rare earth elements from phosphate rock by hydrometallurgical processes - A critical review,” Chemical Engineering Journal, vol. 335, pp. 774-800, 2018.

B. Fritz and C. Noguera, “Mineral Precipitation Kinetics,” Reviews in Mineralogy and Geochemistry, vol. 70, pp. 371-410, 2009.

T. Peretyazhko, J. Zachara, J. Boily, Y. Xia, P. Gassman, B. Arey and W. Burgos, “Mineralogical transformations controlling acid mine drainage chemistry,” Chemical Geology, vol. 262, no. 3-4, pp. 169-178, 2009.

D. Edward Salisbury and D. James Dwight, A text-book of mineralogy: With an extended treatise on crystallography and physical mineralogy, New York: J. Wiley & sons, 1887.

U. Schwertmann and L. Carlson, “The pH-dependent transformation of schwertmannite to goethite at 25 C,” Clay minerals, vol. 40, no. 1, pp. 63-66, 2005.

C. A. Sorrell, Rocks and Minerals: A Guide to Field Identification, New York: St. Martin’s Press, 2001.

L.-M. Li, J.-Q. Ren, G.-X. Xu and X.-Z. Wang, “INDO Studies on the electronic structure of lanthanoid compounds,” International Journal of Quantum Chemistry, vol. 23, no. 4, pp. 1305-1316, 1983.

S. P. Cooper and W. E. Nervik, “The radiochemistry of the rare earths: scandium, yttrium, and actinium,” National Academies, vol. 3020, 1961.

C. Huang, Rare Earth Coordination Chemistry: Fundamentals and Applications, Singapore: John Wiley & Sons (Asia) Pte Ltd, 2011.

I. Persson, “Hydrated metal ions in aqueous solution: How regular are their structures?,” Pure Appl. Chem., vol. 82, no. 10, pp. 1901-1917, 2010.

I. Persson, P. D′Angelo, S. De Panfilis, M. Sandström and L. Eriksson, “Hydration of Lanthanoid(III) Ions in Aqueous Solution and Crystalline Hydrates Studied by EXAFS Spectroscopy and Crystallography: The Myth of the “Gadolinium Break,” Chemistry: A European Journal, vol. 14, no. 10, pp. 3056-3066, 2008.

M. Pourbaix, Atlas of Electrochemical Equilibria in Aqueous Solutions, Houston, Texas: Pergamon Press Ltd., 1966.

I. S. Al-Nafai, Application of Pourbaix Diagrams in the Hydrometallurgical Processing of Bastnasite (M.Sc. Thesis), The Pennsylvania State University, 2015.

R. Janicki, A. Mondry and P. Starynowicz, “Carboxylates of rare earth elements,” Coordination Chemistry Reviews, vol. 340, pp. 98-133, 2017.

B. Weaver, “Fractional Separation of Rare Earths by Oxalate Precipitation from Homogeneous Solution,” Analytical Chemistry, vol. 26, no. 3, pp. 479-480, 1954.

D. Beltrami, G. J.-P. Deblonde, S. Bélair and V. Weigel, “Recovery of yttrium and lanthanides from sulfate solutions with high concentration of iron and low rare earth content,” Hydrometallurgy, vol. 157, pp. 356-362, 2015.

R. H. Byrne and K.-H. Kim, “Rare earth precipitation and coprecipitation behavior: The limiting role of PO43- on dissolved rare earth concentrations in seawater,” Geochimica et Cosmochimica Acta, vol. 57, no. 3, pp. 519-526, 1993.

R. Berner, A. Lasaga and R. Garrels, “The carbonate-silicate geochemical cycle and its effect on atmospheric carbon dioxide over the past 100 million years,” American Journal of Science, vol. 283, pp. 641-683, 1983.

E. H. Oelkers, S. R. Gislason and J. Matter, “Mineral Carbonation of CO2,” Elements, vol. 4, no. 5, pp. 333-337, 2008.

D. S. Goldberg, K. S. Lackner, P. Han, A. L. Slagle and T. Wang, “Co-Location of Air Capture, Subseafloor CO2 Sequestration, and Energy Production on the Kerguelen Plateau,” Environmental Science & Technology, vol. 47, no. 13, pp. 7521-7529, 2013.

C. J. Geankoplis, Transport Processes and Unit Operations, New Jersey: Prentice-Hall International. Inc., 1993.

J. A. Dean, Lange’s Handbook of Chemistry, Fifteenth ed., New York: McGraw-Hill, Inc., 1999.

C. F. Baes and R. E. Mesmer, The Hydrolysis of Cations, New York: Wiley, 1976.

F. H. Firsching and J. Mohammadzadei, “Solubility products of the rare-earth carbonates,” Journal of Chemical & Engineering Data, vol. 31, no. 1, pp. 40-42, 1986.

K. Spahiu and J. Bruno, “A selected thermodynamic database for REE to be used in HLNW performance assessment exercises. No. SKB-TR--95-35,” Swedish Nuclear Fuel and Waste Management Co., Cerdanyola, Spain, 1995.

A. Roine, “HSC Chemistry® [Software],” Outotec, 2015.

L. Giehyeon, B. Jerry M. and F. Gunter, “Removal of trace metals by coprecipitation with Fe, AI and Mn from natural waters contaminated with acid mine drainage in the Ducktown Mining District, Tennessee,” Applied Geochemistry, vol. 17, no. 5, pp. 569-581, 2002.

J. Rosenqvist, P. Persson and S. Sjöberg, “Protonation and Charging of Nanosized Gibbsite (r-Al(OH)3) Particles in Aqueous Suspension,” Langmuir, vol. 18, no. 12, pp. 4598-4604, 2002.

R. Sprycha, J. Jablonski and E. Matijevic, “Zeta Potential and Surface Charge of Monodispersed Colloidal Yttrium(III) Oxide and Basic Carbonate,” Journal q/’Colloid and Inter’lace Science, vol. 149, no. 2, pp. 561-568, 1992.

G. Galt, “Adsorption of salicylhydroxamic acid on selected rare earth oxides and carbonates,” in Graduate Theses & Non-Theses. 124, Montana Tech, 2017.

S. M. Morrison, M. B. Andrade, M. D. Wenz, K. J. Domanik and R. T. Downs, “Lanthanite-(Nd), Nd2(CO3)38H2O,” Acta Crystallographica Section E, vol. E69, pp. i15-i16, 2013.

J.-C. G. Bünzli, “Review: Lanthanide coordination chemistry: from old concepts to coordination polymers,” Journal of Coordination Chemistry, vol. 67, no. 23-24, pp. 3706-3733, 2014.

P. Kim, A. Anderko, A. Navrotsky and R. E. Riman, “Trends in Structure and Thermodynamic Properties of Normal Rare Earth Carbonates and Rare Earth Hydroxycarbonates,” Minerals, vol. 8, no. 3, p. 106, 2018.

S. Arumugam, N. Tajallipour and P. Teevens, “Modeling the influence of iron carbonate scale morphology in sweet corrosion prediction,” in CORROSION, San Antonio, 2014.

R. Barker, D. Burkle, T. Charpentier, H. Thompson and A. Neville, “A review of iron carbonate (FeCO3) formation in the oil and gas industry,” Corrosion Science, vol. 142, pp. 312-341, 2018.

M. M. Benjamin, Water Chemistry, Long Grove, IL: Waveland Press, 2014.

B. Vaziri Hassas, J. Jin, L. X. Dang, X. Wang and J. D. Miller, “Attachment, Coalescence, and Spreading of Carbon Dioxide Nanobubbles at Pyrite Surfaces,” Langmuir, vol. 34, no. 47, pp. 14317-14327, 2019.

S. Dev, A. Sachan, F. Dehghani, T. Ghosh, B. Briggs and S. Aggarwal, “Mechanisms of Biological Recovery of Rare-Earth Elements from Industrial and Electronic Wastes: A Review,” Chemical Engineering Journal, p. 124596, 2020.

S.-Y. Pan, M. A. Du, I.-T. Huang, I.-H. Liu, E.-E. Chang and P.-C. Chiang, “Strategies on implementation of waste-to-energy (WTE) supply chain for circular economy system: a review,” Journal of Cleaner Production, vol. 108, pp. 409-421, 2015.

Z. Zhang, S.-Y. Pan, H. Li, J. Cai, A.G. Olabi, E.J. Anthony, V. Manovic, “Recent advances in carbon dioxide utilization,” Renew. Sustain. Energy Rev. 125, p. 109799, 2020.

S. Pei, S. Pan, Y. Li, P. Chiang, “Environmental benefit assessment for the carbonation process of petroleum coke fly ash in a rotating packed bed,” Environ. Sci. Technol. 51, pp. 10674-10681, 2017.

A. Sanna, M.R. Hallb, M. Maroto-Valera, “Post-processing pathways in carbon capture and storage by mineral carbonation (CCSM) towards the introduction of carbon neutral materials,” Energy Environ. Sci. 5, pp. 7781-7796, 2012.

M. Mikkelsen, M. Jørgensen, F.C. Krebs, “The teraton challenge. A review of fixation and transformation of carbon dioxide,” Energy Environ. Sci. 3, pp. 43-81, 2009.

S.-Y. Pan, T.-C. Chung, C.-C. Ho, C.-J. Hou, Y.-H. Chen, P.-C. Chiang, “CO2 Mineralization and Utilization using Steel Slag for Establishing a Waste-to-Resource Supply Chain,” Sci. Rep. 7, p. 17227, 2017.

R.S. Hedin, “The Use of Measured and Calculated Acidity Values to Improve the Quality of Mine Drainage Datasets,” Mine Water Environ. 25, pp. 146-152, 2006.

N. MacDowell, N. Florin, A. Buchard, J. Hallett, A. Galindo, G. Jackson, C.S. Adjiman, C.K. Williams, N. Shahb, P. Fennell, “An overview of CO2 capture technologies,” Energy Environ. Sci. 3, pp. 1645-1669, 2010.

J. Pan, T. Nie, B. Vaziri Hassas, M. Rezaee, Z. Wen and C. Zhou, “Recovery of rare earth elements from coal fly ash by integrated physical separation and acid leaching,” Chemosphere, vol. 248, p. 126112, 2020.

M. Rezaee and R. Q. Honaker, “Long-term leaching characteristic study of coal processing waste streams,” Chemosphere, vol. 249, p. 126081, 2020.

C. A. Cravotta III, “Dissolved metals and associated constituents in abandoned coal-mine discharges, Pennsylvania, USA. Part 1: Constituent quantities and correlations,” Applied Geochemistry, vol. 23, no. 2, p. 166-202, 2008.

C. A. Cravotta III, “Dissolved metals and associated constituents in abandoned coal-mine discharges, Pennsylvania, USA. Part 2: geochemical controls on constituent concentrations,” Applied Geochemistry, vol. 23, no. 2, p. 203-226, 2008.

R. Q. Honaker, W. Zhang, X. Yang and M. Rezaee, “Conception of an integrated flowsheet for rare earth elements recovery from coal coarse refuse,” Minerals Engineering, vol. 122, pp. 233-240, 2018.

F. Worrall and D. G. Pearson, “Water-rock interaction in an acidic mine discharge as indicated by rare earth element patterns,” Geochimica et Cosmochimica Acta, vol. 65, no.18, p. 3027-3040, 2001.

B. W. Stewart, R. C. Capo, B. C. Hedin and R. S. Hedin, “Rare earth element resources in coal mine drainage and treatment precipitates in the Appalachian Basin, USA,” International Journal of Coal Geology, vol. 169, pp. 28-39, 2017.

W. M. Haynes, CRC Handbook of Chemistry and Physics, New York: CRC Press, 2017.

P. Villars, “Gd2(SO4)3·8H2O (Gd2[SO4]3[H2O]8) Crystal Structure,” Springer-Verlag GmbH, Heidelberg, 2016.

S. Lucas, E. Champion, D. Bregiroux, D. Bernache-Assollant and F. Audubert, “Rare earth phosphate powders RePO4.nH2O (Re=La, Ce or Y)-Part I. Synthesis and characterization,” Journal of Solid State Chemistry, vol. 177, p. 1302-1311, 2004.

R. G. Parr and R. G. Pearson, “Absolute hardness: companion parameter to absolute electronegativity,” J. Am. Chem. Soc., vol. 105, no. 26, p. 7512-7516, 1983.

R. G. Pearson, “Hard and Soft Acids and Bases, HSAB, Part I,” Journal of Chemical Education, vol. 45, no. 9, p. 581-587, 1968.

N. Krishnamurthy and K. C. Gupta, Extractive Metallurgy of Rare Earths (Second Edition), New York: CRC Press, 2016.

E. P. Lokshin, O. A. Tareeva and T. G. Kashulina, “A study of the solubility of yttrium, praseodymium, neodymium, and gadolinium sulfates in the presence of sodium and potassium in sulfuric-phosphoric acid solutions at 20° C.,” Russian Journal of Applied Chemistry, vol. 80, pp. 1275-1280, 2007.

R. Abreu and C. Morais, “Purification of rare earth elements from monazite sulphuric acid leach liquor and the production of high-purity ceric oxide,” Minerals Engineering, vol. 23, pp. 536-540, 2010.

M. E. d. Vasconcellos, S. d. Rocha, W. Pedreira, C. A. d. S. Queiroz and A. Abrao, “Solubility behavior of rare earths with ammonium carbonate and ammonium carbonate plus ammonium hydroxide: Precipitation of their peroxicarbonates,” Journal of Alloys and Compounds, vol. 451, pp. 426-428, 2008.

B. Vaziri Hassas, M. Rezaee and S. V. Pisupati, “Precipitation of Rare Earth Elements from Acid Mine Drainage by CO2 Mineralization Process,” Chemical Engineering Journal, vol. 399, p. 125716, 2020.

W. Zhang and R. Honaker, “Process development for the recovery of rare earth elements and critical metals from an acid mine leachate,” Minerals Engineering, vol. 153, p. 106382, 2020.

M. Balintova and A. Petrilakova, “Study of pH influence on selective precipitation of heavy metals from acid mine drainage,” Chemical Engineering Transactions, vol. 25, p. 1-6, 2011.

V. V. Seredin and S. Dai, “Coal deposits as potential alternative sources for lanthanides and yttrium,” International Journal of Coal Geology, vol. 94, p. 67-93, 2012.

C. Zhanheng, “Global rare earth resources and scenarios of future rare earth industry,” Journal of Rare Earths, vol. 29, no. 1, p. 1-6, 2011.

What is claimed is:

1. A method comprising n stages, wherein the method comprises:
a first of the n stages comprising:
a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, phosphate salt, dihydrogen phosphate salt, hydrogen phosphate salt, or any combinations thereof of the one or more rare earth elements for a first predetermined period of time; wherein the one or more rare earth elements present in the first solution at the first stage comprises at least one or more of light rare earth elements (LREEs), at least one or more of heavy rare earth elements (HREEs), or a combination thereof;
b) adjusting the first predetermined pH of the first solution to reach a second predetermined pH, wherein the second predetermined pH is higher than the first predetermined pH;
c) aging the first solution for a second predetermined period of time at conditions effective to form a first liquid fraction and a first solid fraction, wherein the first solid fraction comprises at least one of the one or more rare earth element salts;
d) separating the first solid fraction from the first liquid fraction; and repeating steps a)-d) for n times, wherein:
a first solution in step a) of each subsequent stage is substantially similar to a first liquid fraction formed in step d) of each preceding stage;
wherein a first predetermined pH at step a) of each subsequent stage is higher than a first predetermined pH at step a) of each preceding stage;
wherein a second predetermined pH in step b) of each subsequent stage is higher than the first predetermined pH at step a) of the same stage,
wherein n is at least 2 stages, and wherein the reagent comprises a carbon dioxide gas, a carbonate salt, bicarbonate salt, phosphate salt, dihydrogen phosphate salt, hydrogen phosphate salt, or a combination thereof.

2. (canceled)

3. (canceled)

4. (canceled)

5. The method of claim 1, wherein the at least one of the one or more rare earth element salts in the first solid fraction of the first stage and a first solid fraction of each subsequent stage comprises a second quantity of the one or more rare earth elements, and wherein the method further comprises measuring the second quantity of the one or more rare earth elements at the first stage and at each subsequent stage.

6. (canceled)

7. The method of claim 5, wherein a total second quantity of the one or more rare earth elements comprises a sum of each of the second quantities measured at each of n^{th} stages, and wherein the total second quantity of the one or more rare earth elements comprises at least 70 % of the first quantity of the one or more rare earth elements present in the first solution in the first stage.

8. (canceled)

9. The method of claim 1, wherein the LREEs comprise one or more of Sc, La, Ce, Pr, Nd, or Sm, and wherein the HREEs comprise one or more of Y, Eu, Gd, Tb, Dy, Ho, Er, Tm, Yb, or Lu.

10. (canceled)

11. The method of claim 1,wherein the first solution in the first stage comprises an acid mine drainage, natural leachate, pregnant leaching solutions, electronic waste residue, industrial waste residue, mining and processing waste streams, or a combination thereof.

12. (canceled)

13. The method of claim 1, wherein the first predetermined pH in step a) of the first stage is from 0 to about 6, and/or wherein the second predetermined pH in step b) of the first stage is at least 0.5 unit higher than the first predetermined pH in step a) of the first stage, or wherein the second predetermined pH in step b) of each subsequent stage of the n stages is at least 0.5 unit higher than the first predetermined pH in step a) of the same stage.

14. The method of claim 1, wherein step b) of the first stage and each subsequent stage comprises adding a base, wherein the base comprises a solution, a gas, a solid, or any combinations thereof.

15. (canceled)

16. (canceled)

17. (canceled)

18. The method of claim 1, wherein the first predetermined time in step a) of the first stage and a first predetermined time in step a) of each subsequent stage is the same or different, and it ranges from greater than 0 to about 72 hours, or wherein the second predetermined time in step c) of the first stage and a second predetermined time in step c) of each subsequent stage is the same or different, and it ranges from greater than 0 to about 72 hours.

19. (canceled)

20. The method of claim 1, wherein the second predetermined pH of the n^{th} stage is from about 8 to about 14.

21. (canceled)

22. The method of claim 5, wherein at least about 70 % of the total second quantity of the one or more rare earth elements is collected at a stage having a second predetermined pH from about 5 to about 8.

23. (canceled)

24. (canceled)

25. The method of claim 5 wherein at least 70 % of the total second quantity of the one or more rare earth elements is collected at a stage having a second predetermined pH at least 0.5 unit lower when compared to substantially identical reference method that does not comprise step a) of treating the first solution with the reagent.

26. The method of claim 1, wherein the first solid fraction in the first stage and the first solid fraction in each subsequent stage further comprises one or more of iron, aluminum, calcium, magnesium, or manganese.

27. (canceled)

28. (canceled)

29. A method comprising:
a) treating a solution having a first predetermined pH and comprising a first quantity of one or more rare earth elements (REEs) and a second quantity of one or more of iron, aluminum, calcium, magnesium, or manganese with a reagent under conditions effective to form:
i) a salt comprising one or more of carbonate of one or more rare earth element, bicarbonate of one or more rare earth element, hydroxycarbonate of one or more rare earth element or a combination thereof, and
ii) a precipitate of one or more of iron, aluminum, calcium, magnesium, or manganese, or a combination thereof for a first predetermined period of time to form a first liquid fraction and a first solid fraction, wherein the first solid fraction comprises the precipitate of one or more of iron, aluminum, calcium, magnesium, or manganese;
b) adjusting the first predetermine pH of the solution to reach a second predetermined pH, wherein the second pH is higher than the first predetermined pH;
c) aging the first solution for a second predetermined period of time at conditions effective to form a second liquid fraction and a second solid fraction, wherein the second solid fraction comprises at least one of the carbonate of one or more rare earth element, bicarbonate of one or more rare earth element, hydroxycarbonate of one or more rare earth element, or a combination thereof; and
d) collecting the first solid fraction and the second solid fraction.

30. The method of claim 29, wherein the precipitate of one or more of aluminum, iron, calcium, magnesium, or manganese comprises a hydroxide, carbonate, bicarbonate, or a combination of thereof.

31. (canceled)

32. The method of claim 29, wherein the reagent is the carbon dioxide gas, the carbonate salt, the bicarbonate salt, or a combination thereof.

33. (canceled)

34. The method of claim 29, wherein the first pH is between 3.5 to 5.5 and wherein the second pH is between 6 and 7.5.

35. (canceled)

36. The method of claim 29, wherein the first solid fraction comprises the precipitate of aluminum.

37. (canceled)

38. The method of claim 29, wherein the second solid fraction comprises at least 75 % of the first quantity of the one or more rare earth elements.

39. The method of claim 29, wherein the solution comprises an acid mine drainage, natural leachate, pregnant leaching solutions, or a combination thereof having an initial pH from 0 to about 6.

40. (canceled)

41. A method comprising n stages, wherein the method comprises: a first of the n stages comprising:
a) treating a first solution having a first predetermined pH and comprising a first quantity of one or more rare earth elements (REEs) with a reagent under conditions effective to form a salt of one or more rare earth elements, wherein the salt comprises at least one of a carbonate, hydroxycarbonate, bicarbonate, or any combinations thereof of the one or more rare earth elements for a first predetermined period of time;
b) adjusting the first predetermined pH of the first solution to reach a second predetermined pH, wherein the second predetermined pH is higher than the first predetermined pH;
c) aging the first solution for a second predetermined period of time at conditions effective to form a first liquid fraction and a first solid fraction, wherein the first solid fraction comprises at least one of the one or more rare earth element salts;
d) separating the first solid fraction from the first liquid fraction; and repeating steps a)-d) for n times, wherein:
a first solution in step a) of each subsequent stage is substantially similar to a first liquid fraction formed in step d) of each preceding stage;
wherein a first predetermined pH at step a) of each subsequent stage is higher than a first predetermined pH at step a) of each preceding stage;
wherein a second predetermined pH in step b) of each subsequent stage is higher than the first predetermined pH at step a) of the same stage; and wherein n is at least 2 stages.
